(19) United States
(12) Patent Application Publication
(10) Pub. No.: US 2011/0246385 A1
(43) Pub. Date: Oct. 6, 2011

(54) AUTOMATICALLY RECALIBRATING RISK MODELS

(75) Inventors: Kasilingam B. LAXMANAN, Wilmington, DE (US); Kathleen L. DOOLEY-MALEY, Charlotte, NC (US); Sherri R. EMERY, Charlotte, NC (US); Gerald F. PARISE, Cherry Hill, NJ (US); Jomar C. UGARTE, Bear, DE (US); Marcus PHILLIPS, Lincoln University, PA (US); Jun NI, Newark, DE (US)

(73) Assignee: BANK OF AMERICA CORPORATION, CHARLOTTE, NC (US)

(21) Appl. No.: 13/079,201

(22) Filed: Apr. 4, 2011

Related U.S. Application Data
(63) Continuation-in-part of application No. 12/605,995, filed on Oct. 26, 2009.

(51) Int. Cl. G06Q 10/00; G06F 17/10

(52) U.S. Cl. 705/348; 703/2

(57) ABSTRACT

Methods, computer readable media, and apparatuses for automatically recalibrating risk models are presented. An identifier of a modeling function may be received. The modeling function may have at least one input variable and a first set of one or more coefficients. Updated performance data that includes at least one input value corresponding to the at least one input variable may be received from a data source. Then, a second set of one or more coefficients may be calculated for the modeling function based on the updated performance data. If it is subsequently determined that the modeling function more accurately models the updated performance data when the second set of one or more coefficients is used in computing a result of the modeling function, then the first set of one or more coefficients may be replaced with the second set of one or more coefficients to recalibrate the modeling function.

### CROSS-REFERENCE TO RELATED APPLICATIONS

This application is a continuation-in-part of U.S. patent application Ser. No. 12/605,995, filed on Oct. 26, 2009, by Sherri R. Emery, et al., and entitled “Automated Validation Reporting for Risk Models,” and which is incorporated herein by reference in its entirety.

### TECHNICAL FIELD

Aspects of this disclosure may generally relate to computer processing technologies and computer software technologies. In particular, aspects of this disclosure may relate to automatically recalibrating risk models, such as risk models and other scoring models that may be used by a financial institution in modeling and analyzing various processes and patterns of behaviors.

### BACKGROUND

Many institutions develop models, such as scoring systems, that provide the institution with information about real-world events and/or populations or help the institution predict future events and/or population changes. For example, banks and other lending institutions use various scoring models for, amongst other things, measuring, managing, predicting, and quantifying credit risk. These scoring models can be important for ensuring that a bank properly balances its risk and remains adequately capitalized.

For example, a bank may develop its own scoring model where they calculate a risk score for each customer based on the customer's credit history, transaction history, employment history, assets, residential history, and/or the like. The score is generated in an effort to produce a score that can be used to identify “good” accounts, i.e., those that present an amount of risk acceptable to the bank, and “bad” accounts, i.e., those that present an amount of risk greater than that which is acceptable to the bank. If, in this example, the scoring model is a good one, the bank should be able to identify a score cutoff that distinguishes between “good” and “bad” accounts with a high probability of actually predicting good and bad accounts.

One example of a scoring model is the FICO score, which is one well-known score used by many institutions to estimate the creditworthiness of an individual. Banks also typically develop many other scoring models of their own to measure and/or predict risk in the credit area as well as in other areas.

Inherently, scoring models are not perfect because they are, by design, simplifications of reality that incorporate certain assumptions about past and future events and causal relationships between the two. As a result, scoring models must be routinely validated to ensure that the model is working as designed and not deteriorating because of an unexpected change in the environment post model development or an inaccurate assumption during model development. In the financial industry, the Office of the Comptroller of the Currency (OCC) in the United States, as well as other banking agencies and organizations around the world, require that banks validate their risk scoring models while they are in use. Therefore, systems and methods are needed to facilitate routine, efficient, consistent, and effective model validations and the reporting of these validations.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

In some instances, an organization's risk models may deteriorate and/or otherwise become less accurate over time as a result of changes in the organization's population of customers, changes in various laws and regulations, changes in the general economic climate, and/or a variety of other factors. Accordingly, it may be advantageous for an organization to regularly recalibrate its risk models from time to time to account for such changing conditions. In practice, a typical risk model may, in essence, be a mathematical function in which one or more input variables (which may correspond to and take their values from data measured by the organization) may be multiplied by one or more coefficients (which may act as weighting factors that emphasize or deemphasize some of the mathematical function's input variables more or less than others) to obtain some result. To “recalibrate” such a risk model, an organization may change the one or more coefficients associated with the model, thereby changing how the model's one or more variables are emphasized with respect to each other. Thus, in the discussion that follows, various methods, devices, and mediums are described which may enable an organization, such as a financial institution, to evaluate and validate one or more risk models, and which may enable the organization to recalibrate such models in cases where model recalibration is desirable and/or necessary.

Aspects of this disclosure relate to automatically recalibrating risk models and other scoring models. According to one or more aspects, a first identifier identifying a modeling function that models performance data may be received. The modeling function may have at least one input variable and a first set of one or more coefficients. Subsequently, updated performance data may be received from a data source, and the updated performance data may include at least one input value corresponding to the at least one input variable of the modeling function. A second set of one or more coefficients may then be calculated for the modeling function based on the updated performance data. It thereafter may be determined whether the modeling function more accurately models the updated performance data when the second set of one or more coefficients is used in computing at least one result of the modeling function instead of the first set of one or more coefficients. If it is determined that the modeling function more accurately models the updated performance data when the second set of one or more coefficients is used in computing the at least one result, then the first set of one or more coefficients may be replaced with the second set of one or more coefficients to recalibrate the modeling function.

### BRIEF DESCRIPTION OF THE DRAWINGS

The present disclosure is illustrated by way of example and not limited in the accompanying figures in which like reference numerals indicate similar elements and in which:

FIG. 1 illustrates an example of a system for automatically generating validation reports for scoring models according to one or more illustrative aspects described herein.

FIG. 2 illustrates another example of a system for automatically generating validation reports for scoring models according to one or more illustrative aspects described herein.

FIG. 3 illustrates an example method of generating validation reports according to one or more illustrative aspects described herein.

FIG. 4 illustrates an example of a user interface for receiving operator input into a model validation reporting system according to one or more illustrative aspects described herein.

FIG. 5 illustrates another example method of generating validation reports according to one or more illustrative aspects described herein.

FIG. 6 illustrates an example of a validation report showing an overview of the results of a particular example Kolmogorov-Smirnov validation of a particular example model according to one or more illustrative aspects described herein.

FIG. 7 illustrates an example of a validation report showing the results of a particular example Kolmogorov-Smirnov validation for a particular example model applied to an overall population according to one or more illustrative aspects described herein.

FIG. 8 illustrates an example of a validation report showing the results of a particular example Kolmogorov-Smirnov validation for a particular example model applied to a first example segment of a population according to one or more illustrative aspects described herein.

FIG. 9 illustrates an example of a validation report showing the results of a particular example Dynamic Delinquency Report validation for a particular example model applied to an overall population according to one or more illustrative aspects described herein.

FIG. 10 illustrates an example of a validation report showing the results of a particular example Dynamic Delinquency Report validation for a particular example model applied to a first example segment of a population according to one or more illustrative aspects described herein.

FIG. 12 illustrates an example of a validation report showing the results of a particular example Actual vs. Predicted validation for a particular example model applied to an overall population according to one or more illustrative aspects described herein.

FIG. 13 illustrates an example of a validation report showing the results of a particular example Actual vs. Predicted validation for a particular example model applied to a first example segment of a population according to one or more illustrative aspects described herein.

FIG. 14 illustrates an example of a validation report showing an overview of the results for a particular example Population Stability Index validation of a particular example model according to one or more illustrative aspects described herein.

FIG. 15 illustrates an example of a validation report showing the results of a particular example Population Stability Index validation for a particular example model applied to an overall population according to one or more illustrative aspects described herein.

FIG. 16 illustrates an example of a validation report showing the results of a particular example Population Stability Index validation for a particular example model applied to a first example segment of a population according to one or more aspects described herein.

FIG. 17A illustrates an example of an operating environment in which various aspects of the disclosure may be implemented.

FIG. 17B illustrates another example of an operating environment in which various aspects of the disclosure may be implemented.

FIG. 18 illustrates a method of automatically validating one or more risk models according to one or more illustrative aspects described herein.

FIGS. 19 and 20 illustrate examples of user interfaces that include risk model validation reports according to one or more illustrative aspects described herein.

FIG. 21 illustrates a method of automatically recalibrating one or more risk models according to one or more illustrative aspects described herein.

FIG. 22 illustrates a method of automatically recalibrating a risk model according to one or more illustrative aspects described herein.

FIGS. 23-24 illustrate examples of user interfaces that include risk model recalibration reports according to one or more illustrative aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

### I. Automated Validation Reporting for Risk Models

### A. Exemplary Embodiments

Some aspects of the disclosure are generally directed to systems, methods, and computer program products configured to automatically, consistently, and efficiently generate standardized model validation reports for multiple models in a systematic fashion based on limited and standardized user input. For example, in one embodiment, a system is provided that has a memory device and a processor operatively coupled to the memory device. In one embodiment, the memory device includes a plurality of datastores stored therein, each datastore of the plurality of datastores including scores generated from a different model from a plurality of models. In one embodiment, the processor is configured to: (1) select a validation metric from a plurality of validation metrics; (2) select a model from the plurality of models; (3) access a datastore from the plurality of datastores, the accessed datastore comprising scores generated using the selected model; (4) generate validation data based at least partially on the selected validation metric and scores associated with the selected model; and (5) generate a validation report from the validation data. In one embodiment, the plurality of models include risk models for quantifying risk associated with each credit account of a financial institution.

In one embodiment, the system further includes a user input interface configured to receive user input. For example, in one embodiment, the user input includes a requested validation metric and a requested model. In such an embodiment, the processor may be configured to select the selected validation metric based on the requested validation metric, and to select the selected model based on the requested model.

In some embodiments, the processor is configured to generate the validation report in HTML format. In some embodiments, the processor is further configured to communicate the validation report to one or more predefined computers or accounts. In some embodiments, the processor is configured to generate the validation data and the validation report periodically according to a predefined schedule. In some embodiments, the processor is configured to highlight validation data in the validation report that is within a predefined range of values.

In one embodiment, the processor is further configured to: (1) determine a plurality of different population segments among an overall population; (2) generate separate validation data for the overall population and for each of the plurality of different population segments; (3) generate an overview report having a table summarizing a portion of the validation data for each of the plurality of different population segments; (4) generate an overall report having a table presenting the validation data for the overall population; and (5) generate a segment level report presenting the validation data for each of the plurality of different population segments. In some such embodiments, the plurality of different population segments are determined by the processor at least partially based on a measure of the length of time that an account has been delinquent. In some such embodiments, the processor is further configured to automatically, based on user input, generate a header for the validation report that includes a date of the validation report, a validation metric identifier identifying the selected validation metric, a model identifier identifying the selected model, a performance window, and an identification of the population segment(s) presented in the validation report.

In one exemplary embodiment, the selected validation metric is a Kolmogorov-Smirnov (K-S) metric and the processor is configured to determine a plurality of different population segments among an overall population and generate separate validation data for each of the plurality of different population segments. In one such embodiment, the validation report includes, for each of the plurality of different population segments, a segment definition, a current K-S value, a past K-S value, and a percentage difference between the past K-S value and the current K-S value.

In another exemplary embodiment, the selected validation metric is a comparison of actual events to predicted events, and the processor is configured to determine a plurality of different population segments among an overall population and generate separate validation data for each of the plurality of different population segments. In one such embodiment, the validation report includes, for each of the plurality of different population segments, a segment definition, an actual event rate, a predicted event rate predicted based on the selected model, and a percentage of the actual events predicted by the model.

In another exemplary embodiment, the selected validation metric is a Population Stability Index (PSI), and the processor is configured to determine a plurality of different population segments among an overall population and generate separate validation data for each of the plurality of different population segments. In one such embodiment, the validation report includes, for each of the plurality of different population segments, a segment definition and a PSI value.

In another exemplary embodiment, the selected validation metric is a Kolmogorov-Smirnov (K-S) metric, and the validation report generated by the processor includes an overall K-S value, a benchmark K-S value, a gains chart, and, for each score decile, a cumulative good percentage, a cumulative bad percentage, and a K-S value. In another exemplary embodiment, the selected validation metric is a Dynamic Delinquency Report (DDR), and the validation report generated by the processor includes a DDR graph the percentage of accounts late, 30 days-past-due (DPD), 60 DPD, 90 DPD, and charged-off versus score decile, and, for each score decile, a late percentage, a 30 DPD percentage, a 60 DPD percentage, a 90 DPD percentage, and a charge-off percentage. In another exemplary embodiment, the selected validation metric is a comparison of actual events to predicted events predicted by the selected model, and the validation report generated by the processor includes a graph of the percentage of actual and predicted events by score decile and, for each score decile, an actual event rate, a predicted event rate predicted based on the selected model, and a percentage of the actual events predicted by the model. In another exemplary embodiment, the selected validation metric is a Population Stability Index, and the validation report generated by the processor includes, for each of a plurality of score ranges, a benchmark frequency percentage, a current frequency percentage, a ratio of the current frequency percentage to the benchmark frequency percentage, a natural log of the ratio, and a PSI value.

One or more embodiments may also include a method involving: (1) receiving electronic input comprising a requested validation metric and a requested model; and (2) using a processor to automatically, based on the electronic input: (a) select the requested validation metric from a plurality of validation metrics; (b) select the requested model from a plurality of models; (c) access a datastore from a plurality of datastores, the accessed datastore comprising scores generated using the requested model; (d) generate validation data based at least partially on the requested validation metric and scores associated with the requested model; and (e) generate a validation report from the validation data.

### B. Detailed Discussion of Exemplary Embodiments

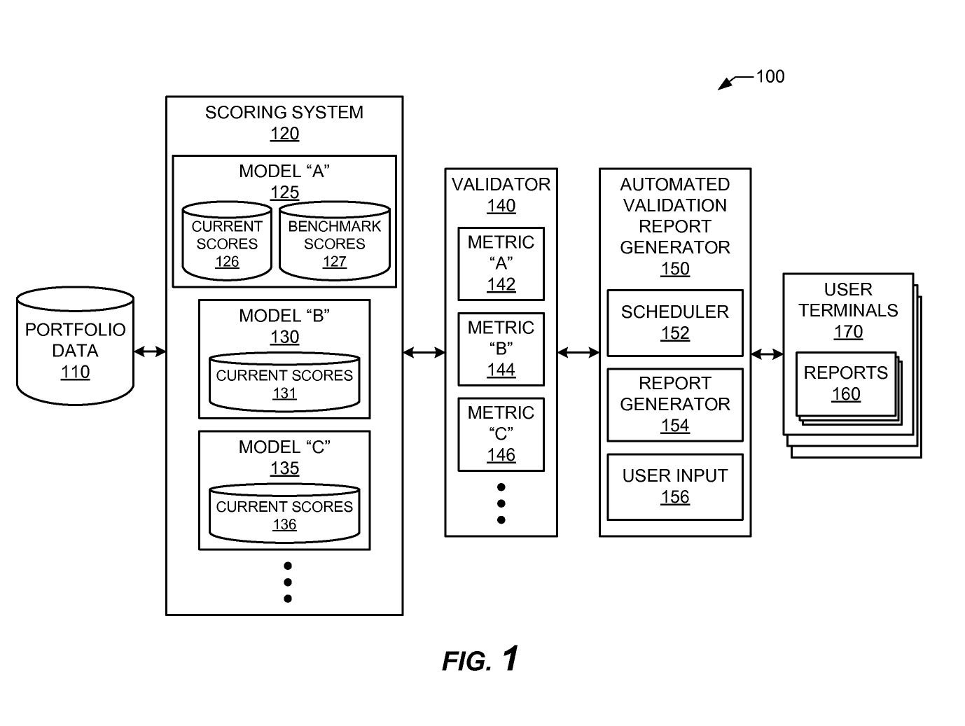

FIG. 1 is a block diagram illustrating a system 100 for automatically generating validation reports for scoring models according to one or more illustrative aspects described herein. The system 100 includes an institution's portfolio data 110 which includes the institution's data related to the subject of the scoring model. For example, for a bank engaged in validation of its risk models, where, for example, the risk models attempt to quantify the risk inherent in the bank's consumer credit portfolio, the portfolio data 110 may include such information as consumer information (e.g., name, social security number, address, and/or the like) and each consumer's credit information (e.g., number and type of credit products, credit limits, current account balances, balance histories, payment histories, interest rates, minimum payments, late payments, delinquencies, bankruptcies, and/or the like).

The system 100 further includes a scoring system 120 configured to calculate and store the scores generated by each of one or more models used by the institution, such as models “A” 125, “B” 130, and “C” 135 shown in FIG. 1 for illustration purposes. The scoring system 120 includes, for each model, a model definition, such as an algorithm for computing a particular score, and rules for using the score to make or inform certain decisions. Each model will generally include a datastore of current scores, such as current scores 126, 131, and 136, that represent recent scores calculated from the model definition and the portfolio data 110. Some models, such as model “A” 125, also include score histories or benchmark scores 127 (sometimes referred to as “development scores”). The benchmark scores 127 are scores calculated at some previous point in time, such as during development of the model, that can be used as benchmarks for comparing changes in the portfolio or deterioration of the model over time. The scoring system 120 may include one or more computers for gathering relevant portfolio data, calculating scores for the one or more models, and storing the scores in a memory device.

The system 100 further includes a validator 140 configured to calculate and store certain validation metrics, such as metrics “A” 142, “B” 144, and “C” 146 shown in FIG. 1 for illustration purposes. These metrics are calculated from the current scores and, in some cases, the benchmark scores, of a model and may be used to assess the performance of the model. These metrics may be defined by known statistical algorithms or by algorithms generated by the institution. Some examples of known metrics include, for example and without limitation, a Kolmogorov-Smirnov (K-S) test, a Population Stability Index (PSI), and an actual versus prediction comparison. In the banking context, another example of a validation metric is a Dynamic Delinquency Report (DDR). The validator 140 may include one or more computers for gathering relevant model data, calculating validation metrics for the one or more models, and storing the metrics in a memory device.

The system 100 further includes an automated validation report generator 150 configured to automatically generate consistent and periodic validation reports based on certain limited user inputs 156. In this regard, one embodiment of the automated validation report generator 150 includes a report generator 154 for generating the validation reports 160, and a scheduler 152 for automatically initiating the validation and/or report generation processes according to a user-defined schedule. For example, in one or more arrangements, the scheduler 152 may be configured to initiate the validation report process daily, weekly, monthly, quarterly, annually, or according to any other periodic or user-defined schedule. The validator 140 may include one or more computers for receiving user input, initiating the calculation of scores and/or validation metrics, gathering score and metric data, generating validation reports from the score and metric data, and communicating reports 160 to the proper persons or devices 170. It should be appreciated that, although shown in FIG. 1 as being conceptually separate systems, two or more of the scoring system 120, validator 140, report generator 150, and the user terminal 170 may be combined in a single computer or other system.

As described in greater detail hereinbelow, the validation report 160 may be in any predefined or user-defined format and may be provided to a user via any predefined or user-defined communication channel. In one embodiment, the validation report 160 includes tables and graphs presented in Hyper Text Markup Language (HTML) format.

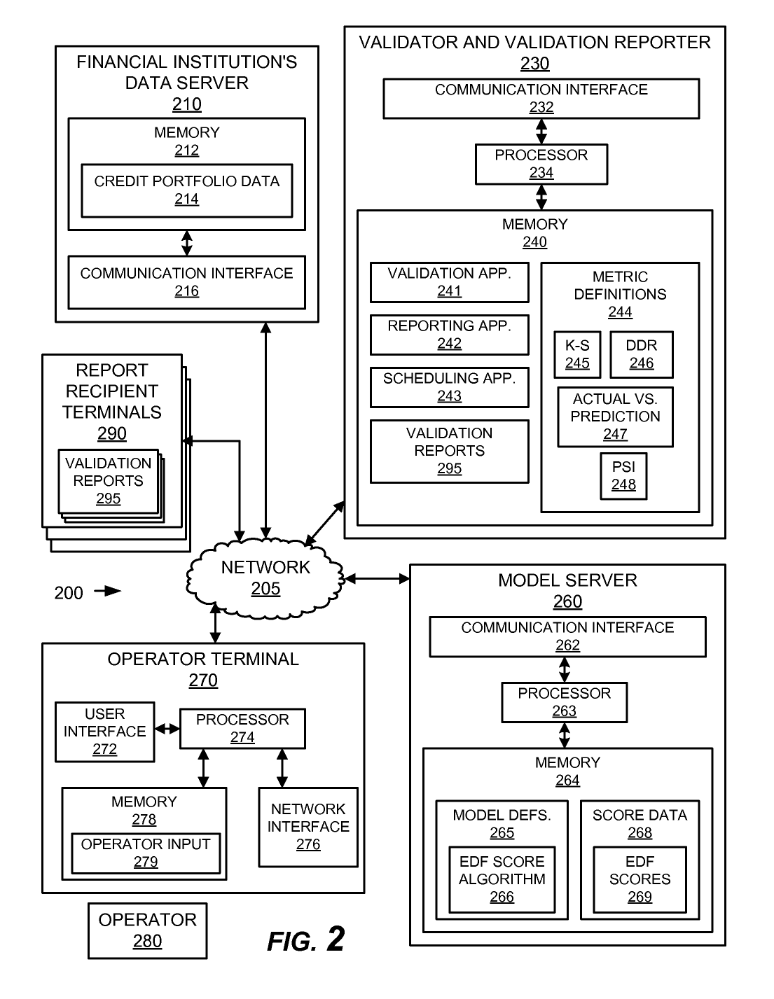

FIG. 2 illustrates a block diagram of a more-detailed example of a model validation reporting system 200 according to one or more illustrative aspects described herein. It will be appreciated that, although FIG. 2 illustrates a system 200 comprised of a number of different computer devices, other embodiments may combine two or more, or even all, of these devices into a single computer device.

In the exemplary embodiment illustrated in FIG. 2, the model validation reporting system 200 includes a financial institution and a financial institution's data server 210 having a communication interface 216 operatively coupled to memory 212. The communication device 216 is configured to communicate data between the memory 212 and one or more other devices on a network 205. The memory 212 includes data about the financial institution's product portfolio, such as the financial institution's credit portfolio data 214. The credit portfolio data 214 may include, for example, information about the financial institution's credit products (e.g., balances and limits on revolving credit accounts, outstanding and original loan amounts, payment histories, balance histories, interest rate histories, delinquencies, bankruptcies, charge-offs, and/or the like) and/or information about the customer(s) associated with each credit product (e.g., names, social security numbers, addresses and other customer contact information, employment history, resident history, and/or the like).

As used herein, the term “financial institution” generally refers to an institution that acts to provide financial services for its clients or members. Financial institutions include, but are not limited to, banks, building societies, credit unions, stock brokerages, asset management firms, savings and loans, money lending companies, insurance brokerages, insurance underwriters, dealers in securities, credit card companies, and similar businesses. It should be appreciated that, although example embodiments are described herein as involving a financial institution and models for assessing the financial institution's credit portfolio, other embodiments may involve any type of institution and models for assessing any type of portfolio, population, or event.

As used herein the term “network” refers to any communication channel communicably connecting two or more devices. For example, a network may include a local area network (LAN), a wide area network (WAN), a global area network (GAN) such as the Internet, and/or any other wireless or wireline connection or network. As used herein, the term “memory” refers to a device including one or more forms of computer-readable media for storing instructions and/or data thereon, as computer-readable media is defined hereinbelow. As used herein, the term “communication interface” generally includes a modem, server, and/or other device for communicating with other devices on a network, and/or a display, mouse, keyboard, touchpad, touch screen, microphone, speaker, and/or other user input/output device for communicating with one or more users.

In the illustrated exemplary embodiment, the model validation reporting system 200 further includes a model sever 260 configured to store information about one or more scoring models and configured to generate scores by applying model definitions 265 to the credit portfolio data 214. In this regard, the model server 260 includes a processor 263 operatively coupled to a memory 264 and a communication interface 262.

As used herein, a “processor” generally includes circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Referring again to FIG. 2, in the illustrated example embodiment, the memory 264 includes one or more model definitions 265 stored therein. Each model has a model definition that includes an algorithm or other instruction for computing model-specific scores from the portfolio data 214. For example, in FIG. 2, the model definitions 265 include an algorithm 266 for computing an Expected Default Frequency (EDF) score. This example score algorithm is, in one embodiment, generated by the financial institution and results in a score used by the financial institution to estimate the probability that a customer will fail to make scheduled debt payments over a specified period of time. In one embodiment, the processor 263 is configured to execute the algorithm 266 stored in the memory 264 and generate score data 268, such as EDF scores 269, from the portfolio data 214 stored in the data server 210. The score data 268 is then also stored in the memory 264. It will be appreciated that EDF is used herein merely as an example scoring model and that any scoring model(s) may be used.

The illustrated embodiment of the model validation reporting system 200 further includes a validator and validation reporter 230 configured to generate validation metrics and prepare reports regarding the same. In this regard, the validator and validation reporter 230 includes a processor 234 operatively coupled to a communication interface 232 and a memory 240.

The memory 240 includes a plurality of validation metric definitions 244 stored therein that include algorithms and/or other instructions for generating certain validation metrics. These validation metrics are used to assess and validate the models and may include validation metrics generated by the institution or validation metrics known generally in the statistical arts. For example, in one embodiment the memory includes definitions for: a Kolmogorov-Smirnov (K-S) analysis 245, a Dynamic Delinquency Report (DDR) 246, an Actual vs. Prediction comparison 247, and a Population Stability Index (PSI) 248. In other embodiments, the memory may include definitions for any other type of validation metric.

A K-S analysis is used to determine the maximum difference between the cumulative percentages of two groups of items, such as customer credit accounts (e.g., “good” versus “bad” accounts), by score. For example, if the scoring model being analyzed could perfectly separate, by score, a population of customer accounts into a group of bad accounts and a group of good accounts, then the K-S value for the model over that population of accounts would be one-hundred. On the other hand, if the scoring model being analyzed could not differentiate between good and bad accounts any better than had accounts been randomly moved into the good and bad categories, then the K-S value for the model would be zero. In other words, the higher the K-S value, the better the scoring model is at performing the given differentiation of the given population.

A DDR is a report examining the delinquency rates of a population of customers in relation to the scores generated by the scoring model. The DDR can be used to determine if a model is accurately predicting delinquencies and which scores correlate with delinquencies in a specified population of customers.

An Actual vs. Prediction comparison compares actual results versus the results predicted using the model at some previous point in time, such as during development of the model.

A PSI is a statistical index used to measure the distributional shift between two score distributions, such as a current score distribution and a baseline score distribution. A PSI of 0.1 or less generally indicates little or no difference between two score distributions. A PSI from 0.1 to 0.25 generally indicates that some small change has taken place in the score distribution, but it may or may not be statistically significant. A PSI above 0.25 generally indicates that a statistically significant change in the score distribution has occurred and may signify the need to look at the population and/or the model to identify potential causes and whether the model is deteriorating.

As further illustrated in FIG. 2, the memory 240 further includes a validation application 241, a reporting application 242, and a scheduling application 243. The validation application 241 includes computer executable program code that, based on operator-defined input and/or pre-defined rules, instructs the processor 234 to gather the appropriate score data and generate the validation metrics using the appropriate metric definitions 244. The reporting application 242 includes computer executable program code that, based on operator-defined input and/or pre-defined rules, instructs the processor 234 to generate certain validation reports 295 in a particular format. The scheduling application 243 includes computer executable program code that, based on operator-defined input and/or pre-defined rules, instructs the processor 234 when to run the validation application 241 and the reporting application 243 to generate the validation reports 295. In some embodiments, the scheduling application 243 also determines, based on operator input and/or on pre-defined rules, which recipient terminals 290 (e.g., personal computers, workstations, accounts, etc.) or persons to send the validation reports 295 to. It will be appreciated that, although FIG. 2 illustrates conceptually separate applications, other embodiments may either include separate applications with separate and distinct computer-executable code or have combined applications that share and/or intermingle computer-executable code.

The illustrated embodiment of the of the model validation reporting system 200 further includes an operator terminal 270, which may be, for example, a personal computer or workstation, for allowing an operator 280 to send input 279 to the validation reporter 230 regarding generation of validation reports 295. In this regard, the operator terminal generally includes a communication interface having a network interface 276 for communicating with other devices on the network 205 and a user interface 272 for communicating with the operator 280. These interfaces are communicably coupled to a processor 274 and a memory 278. The operator 280 can use the user interface 272 to create operator input 279 and then use the network interface 276 to communicate the operator input 279 to the validation reporter 230.

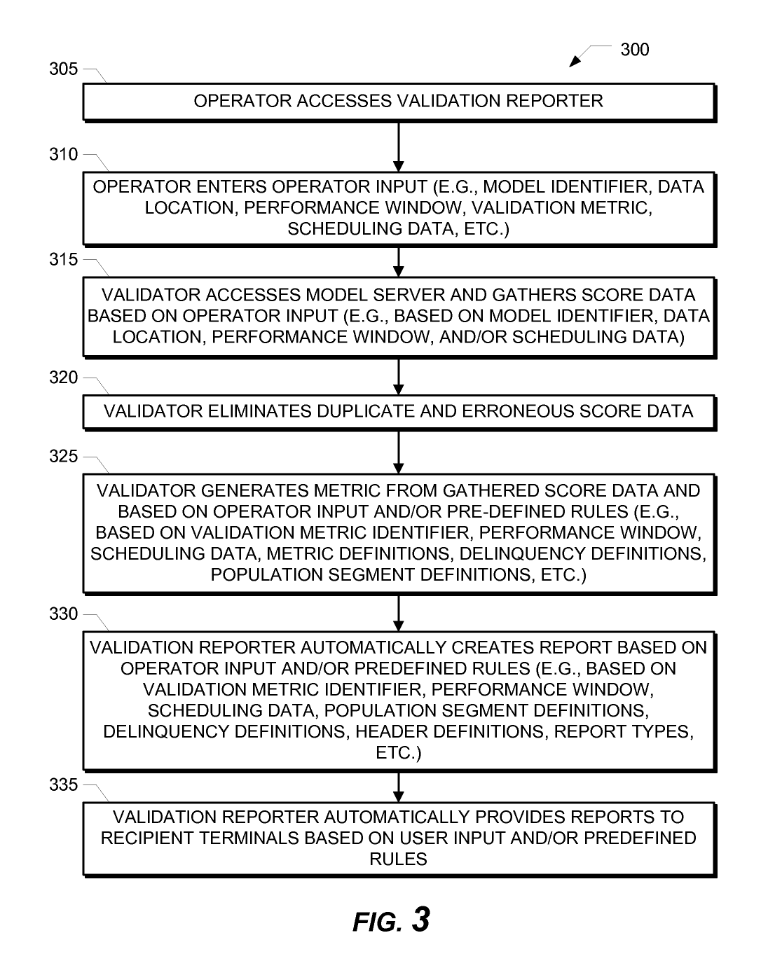

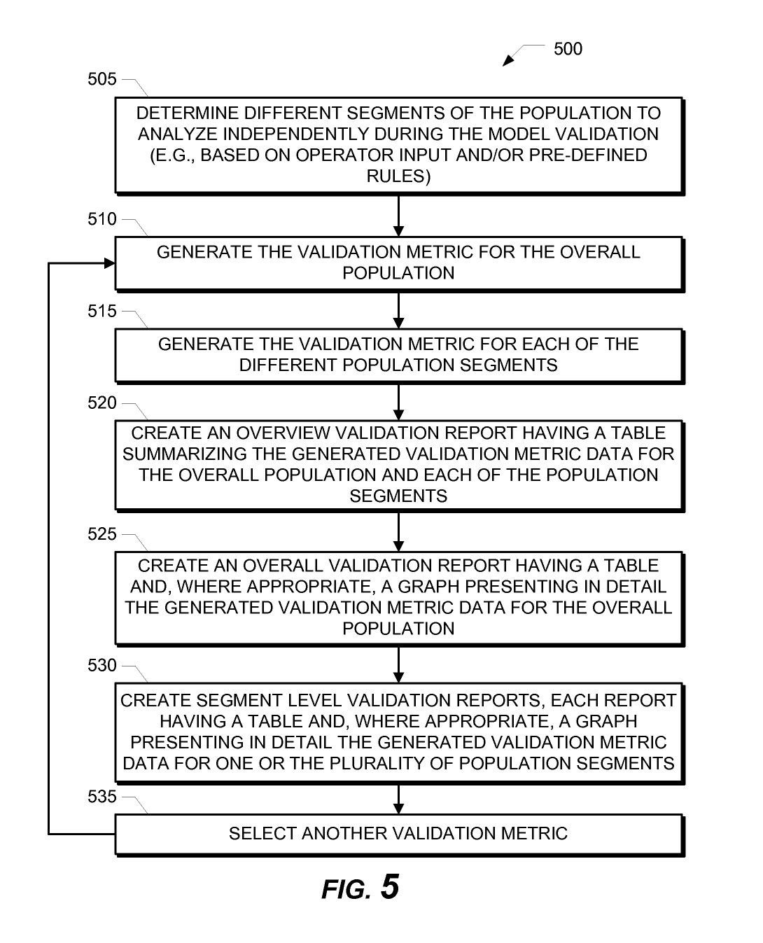

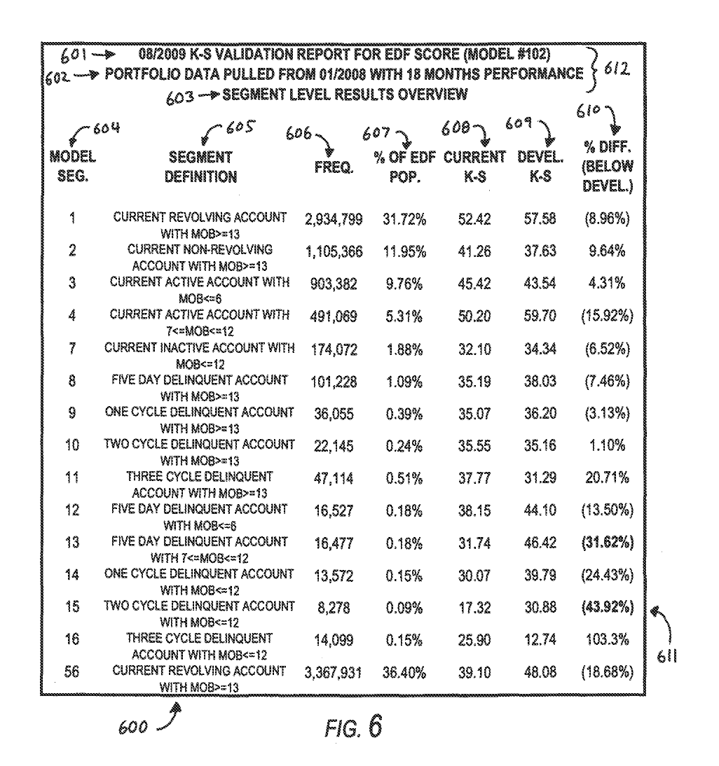

FIGS. 3 and 5 provide flow diagrams illustrating procedures for generating validation reports that, in some arrangements, are performed by the systems described herein, such as by the systems described in FIGS. 1 and 2. It will be appreciated that although a particular order of steps is described herein and illustrated in these figures, other embodiments may perform these processes in other orders. As represented by block 305 in FIG. 3, in one embodiment an operator 280 accesses the validation reporter 230. For example, in one embodiment, the operator 280 uses an operator terminal 270 to access the validation reporter 230.

As represented by bock 310, the operator 280 communicates operator input 279 to the validation reporter 230. The operator input 279 may include such information as, for example, the model or models to be validated, the validation metrics to use in the validation, the type and/or format of the reports, the portfolio data to use for the model and model validation, segments of the overall population to analyze in the validation, report scheduling information, report recipient information, delinquency definitions, identification of benchmark data, performance window(s) to analyze in the validation, and/or the like.

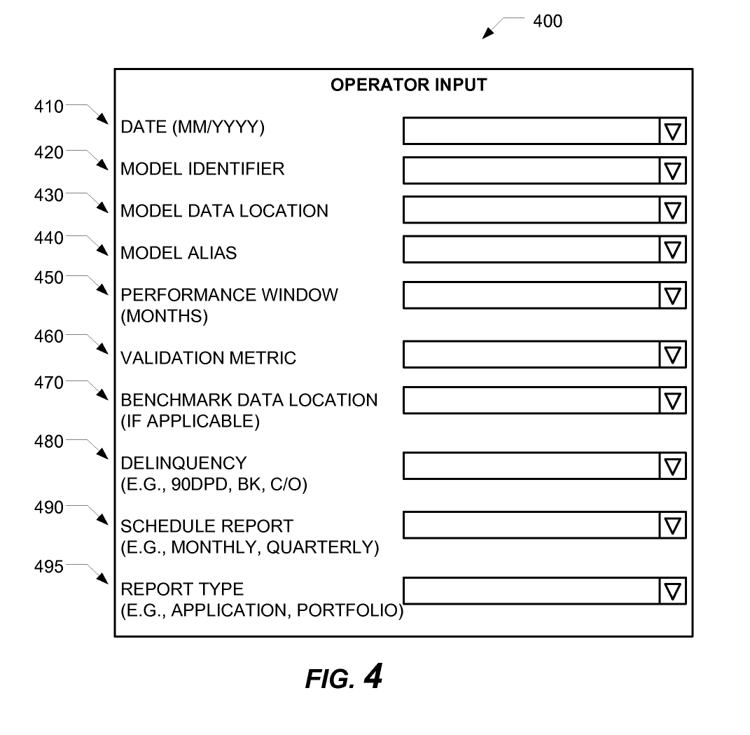

In some arrangements, the operator 280 enters input by accessing a portion of the computer executable program code of the validation application 241, reporting application 242, and/or scheduling application 243 to modify certain input variables in the code. In another embodiment, the operator 280 generates a data file, such as a text file, that has the operator input 279 presented therein in a particular predefined order and/or format so that the text file can be read by the validation application 241, reporting application 242, and/or scheduling application 243. In still another embodiment, the validation reporter 230 prompts the operator 280 for operator input 279 by, for example, displaying a graphical user input interface on a display device of the user interface 272. For example, FIG. 4 illustrates an exemplary graphical user interface 400 for receiving operator input 279 into the model validation reporting system 200 according to one or more illustrative aspects described herein. It should be appreciated that the user input illustrated in FIG. 4 is illustrative of only one embodiment. Other embodiments may include more or less inputs and inputs of a different character.

As illustrated in FIG. 4, the operator input 279 may include, for example: (1) the current date 410 for dating the validation reports and/or for beginning a scheduled periodic validation report program; (2) one or more model identifiers 420 for identifying one or more scoring models to be the subject of the validation reports; (3) one or more data locations 430 for model scores and/or portfolio data used to calculate model scores; (4) one or more model aliases 440 for identifying the model being validated in the heading of each validation report; (5) one or more performance windows 450 for indicating a time period over which to calculate and display the validation metrics; (6) one or more validation metrics 460 for identifying the one or more validations to perform and for which to prepare reports; (7) one or more benchmark data locations 470 for identifying one or more benchmarks against which current data should be compared, (where applicable to the validation being performed); (8) one or more delinquency definitions 480 for identifying what type of delinquency measure(s) to use in the validation reports (e.g., 30 days-past-due (DPD), 60 DPD, 90 DPD, bankruptcy, charge-off, etc.); (9) schedule information 490 for scheduling the validation and/or validation report generation process periodically or on one or more specific dates; and (10) one or more report types 495 for identifying the type of report (e.g., a “portfolio” report on current customer accounts, an “application” report on current credit applications, etc.).

In some arrangements, the graphical user interface 400 allows the operator to select a button adjacent to the input box that allows the user to view predefined or previously-entered input related to the particular input type. In some embodiments, not all operator inputs are needed for all validation report types and requests. As such, in some embodiments, the different user inputs displayed in the graphical user interface are grayed-out or not displayed depending on other operator inputs and their relevance to the particular report request indicated thereby.

Referring again to FIG. 3, in one embodiment the validator 230 accesses the model server 260 and gathers score data 268 based on the operator input 279, as illustrated by block 315. For example, in one embodiment, the validator 230 obtains score data 268 for models identified by the model identifier input and/or the data location input. The validator 230 may also, in some embodiments, only gather score data 268 relevant to an operator-imputed performance window and only based on an operator-input validation schedule.

In some embodiments, in response to the validator 230 requesting score data 268 from the model server 260, the model server 260 contacts the financial data server 210 to obtain relevant portfolio data 214 and then calculates the appropriate score data 268 needed to satisfy the validator's request. However, in other embodiments, the score data 268 is routinely calculated from the portfolio according to its own schedule and thus is available to the model server 260 before the validator 230 even submits the request to the model server 260.

As represented by block 320, in one embodiment, once the validator 230 receives the score data 268, the validator 230 begins validation by eliminating duplicate and/or erroneous scores from the score data 268. For example, in one embodiment, the validator checks social security numbers associated with each score to eliminate multiple scores associated with the same social security number and scores not associated with a valid social security number. The validator 230 may also be configured to eliminate any scores that appear erroneous because they have score values outside of a range of possible score values for the particular score.

As represented by block 325, in one embodiment, the validator 230 then generates the validation metric data from the gathered score data 268 based on operator input 279 and/or pre-defined rules. For example, in one embodiment, the operator input 279 specifies a validation metric, e.g., K-S, PSI, Actual vs. Predicted, DDR, and/or the like, and, based on this input, the validator 230 selects the appropriate metric definition 244. The metric definition 244 includes instructions for calculating, displaying, and/or otherwise generating the selected validation metric data needed for the validation reports 295.

As represented by block 330, the validation reporter 230 then automatically creates the validation reports 295 from the validation metric data based on the operator input 279 and/or predefined rules. Embodiments of the process of generating validation reports 295 are described in greater detail with respect to FIGS. 5-16. As represented by block 335, in one embodiment, once the validation reports 295 are created, the validation reporter 230 automatically sends the validation reports 295 to certain recipient terminals 290 or accounts based on operator input 280 and/or predefined rules. The validation reports 295 can then be displayed to or printed by appropriate personnel.

Referring now to FIG. 5, a flow chart is provided illustrating an exemplary process for generating consistent standardized validation reports according to one or more illustrative aspects described herein. As represented by block 505 in FIG. 5, the validation reporter 230 first determines different segments of a given population to analyze independently during the model validation. For example, a model may be examined for validation purposes across the entire population of an institution's customers/accounts or prospective customers/accounts. The model may also be examined for validation purposes across only certain segments of the overall population to determine if a model performs particularly well or poorly over different population segments. In one embodiment, the population segments used during the validation are provided by an operator 280. In other embodiments, the population segments are based on predetermined rules or written directly into the reporting application's computer executable program code.

For example, in one embodiment, the validation reporter 230 is configured to validate risk models used to quantify risk of its customers associated with the institution's credit portfolio. In some such embodiments, the validation reports include validation metric data across not just the entire population of customers, but also across a plurality of segments of the population where each population segment is defined by some range of values of a credit metric, a type of credit metric, or some combination of credit metrics and/or ranges of credit metrics. For example, in one embodiment, the overall population is all credit accounts in the institution's credit portfolio, and the population segments are based on the type of credit account, the current number of months outstanding balance (MOB) of the account, and/or the number of cycles that the account has been delinquent.

As represented by block 510 in FIG. 3, once the population segments are determined, the validation reporter 230 then generates the validation metric data for the overall population and, as represented by block 515, for each of the different population segments determined in step 505.

As represented by block 520, once the validation metric is computed, the validation reporter 230 creates an overview validation report having a table summarizing the generated validation metric data for the overall population and for each of the population segments. For example, FIG. 6 provides a sample segment level overview report 600 according to one or more illustrative aspects described herein.

More particularly, FIG. 6 illustrates an example validation report 600 showing an overview of the results of a particular example K-S validation of a particular example model according to one or more illustrative aspects described herein. The report 600 includes a header 612 created automatically by the validation reporter 230. The header 612 includes a first portion 601 that includes the date of the report, the validation metric that the report relates to, and the scoring model name and identifier. In one embodiment, first portion 602 of the header 612 is generated from the date, validation metric, model alias, and model identifier entered by the operator 280 as operator input 279. In the illustrated example, the report was generated on August 2009, is directed to the K-S validation statistic, and is validating model #102 which, in this example, is a type of EDF score.

The report header 612 also includes a second portion 602 that identifies the performance window used during for the validation. In one embodiment, this performance window is determined based on a performance window entered by the operator 280 in the operator input 279. In the illustrated example, the validation report is generated from model data over an eighteen month performance window dating back to January 2008.

The report header 612 also includes a third portion 603 that identifies what is displayed in the current portion of the report. In the illustrated example, the first portion of the report is a “segment level results overview” that summarizes the validation results over each population segment.

In this regard, in one embodiment where the validation metric is a K-S statistic, the segment level results overview portion of the report provides a table showing, for each population segment, a segment identifier 604, a segment definition 605, a frequency 606, a percentage of population 607, a current K-S value 608, a development K-S value 609, and a percentage difference between the current and development K-S values 610. More particularly, the segment identifier 604 is an identifier used by the institution to identify a particular population segment. The segment definition 605 is a description of which accounts make up the segment of the population. The frequency 606 represents the number of accounts in the population segment. The percentage of population 607 represents the percentage of the overall population represented by the population segment. The current K-S value 608 is the value of the K-S statistic currently for the population segment. The development K-S value 609 represents the value of the K-S statistic that was calculated for the population segment at the time of development of the model. The percentage difference 610 illustrates the percentage change in the K-S statistic between development and the current date. As illustrated, the percentage can be either positive, indicating an increase in the K-S value since development, or negative, indicating a decrease in the K-S value since development.

As illustrated in FIG. 6, some values in the table may be highlighted (e.g., by bold text, color text, text size, italics, underlining, and/or the like) where the value exceeds some predefined threshold or is otherwise in some predefined range of values. For example, in FIG. 6, values of the percentage difference 610 are highlighted if they represent greater than a 30% reduction in the K-S value since development. As described above, since a higher K-S value indicates better model performance, a significant reduction in K-S can represent deterioration of the model and should be brought to the attention of the report reviewer. For example, in FIG. 6, value 611 is in bold text because it shows that the K-S value for this EDF model has decreased 43.92% since development with respect to population segment number sixteen. This may signify, for example, deterioration of the model or a change in population segment number sixteen that makes certain assumptions used for the model no longer accurate.

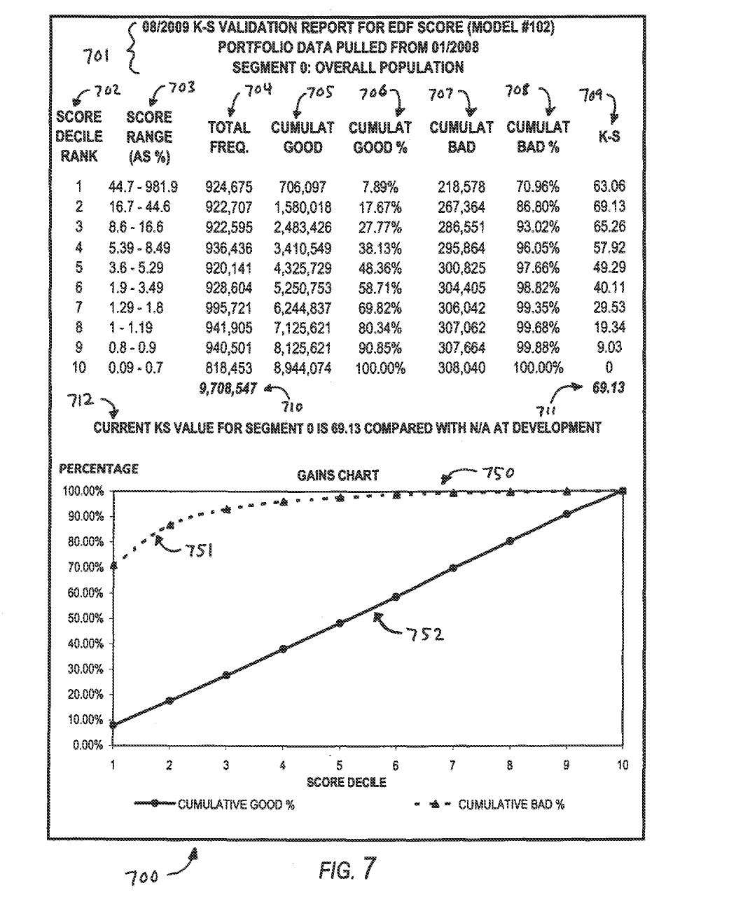

Referring again to FIG. 5, as represented by block 525, the validation reporter 230 also creates an “overall validation report” having a table and, where appropriate, a graph presenting in detail the generated validation metric data for the overall population. For example, FIG. 7 illustrates an example validation report 700 showing the results of a particular example K-S validation for a particular example model applied to the overall population, in accordance with an embodiment. The report header 701 includes the other header information described above with respect to FIG. 6, but now indicates that this portion of the report relates to “Segment 0” which is the overall population. In the illustrated example, the segment level report includes a table showing score decile rank 702 and then for each score decile rank 702 a score range 703, total frequency 704, cumulative good 705, cumulative good percentage 706, cumulative bad 707, cumulative bad percentage 708, and K-S value 709. In one embodiment, the population is divided into score deciles which are ten equal groups of the overall population by score. The score decile rank 702 indicates one of the ten score deciles. The score range 703 indicates the score range in the decile. The total frequency 704 indicates the number of accounts in the decile. The cumulative good value 705 shows the cumulative number of good accounts in a group defined by the current decile and all lower ranked deciles. The cumulative good percentage 706 shows the cumulative percentage of good accounts in a group defined by the current decile and all lower ranked deciles. The cumulative bad 707 shows the cumulative number of bad accounts in a group defined by the current decile and all lower ranked deciles. The cumulative bad percentage 708 shows the cumulative percentage of bad accounts in a group defined by the current decile and all lower ranked deciles. The K-S value 709 is the maximum distance between the cumulative bad percentage curve 751 and the cumulative good percentage curve 752 in the gains chart 750.

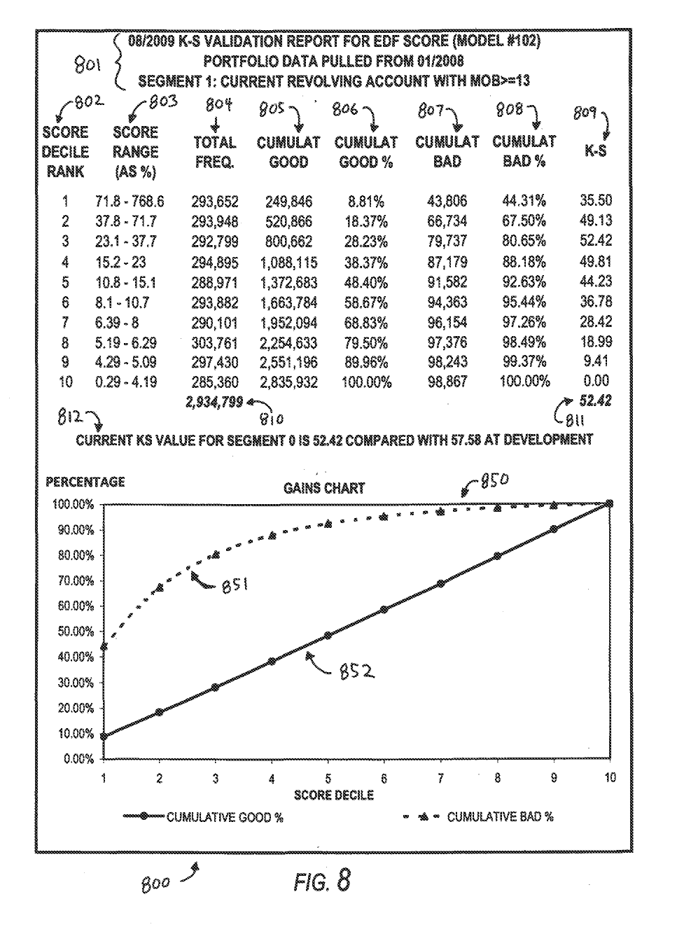

Referring again to FIG. 5, as represented by block 530, the validation reporter 230 also creates segment level validation reports, each report having a table and, where appropriate, a graph presenting in detail the generated validation metric data for each one or the plurality of population segments displayed in the overview report. For example, FIG. 8 illustrates an example validation report 800 showing the results of a particular example K-S validation for a particular example model applied to a first example segment of the population, in accordance with an embodiment. This report 800 is similar to the report 700 described in FIG. 7 for the overall population but, instead, as shown in the header, reports on K-S validation data only for “Segment 1” which is all revolving credit accounts in the overall population that have a MOB greater than or equal to thirteen.

Referring again to FIG. 5, as represented by block 535, another validation metric is then selected by the operator 280 or automatically by the validation reporter 230 and the process returns to block 510 so that similar validation reports can be generated for the newly-selected validation metric.

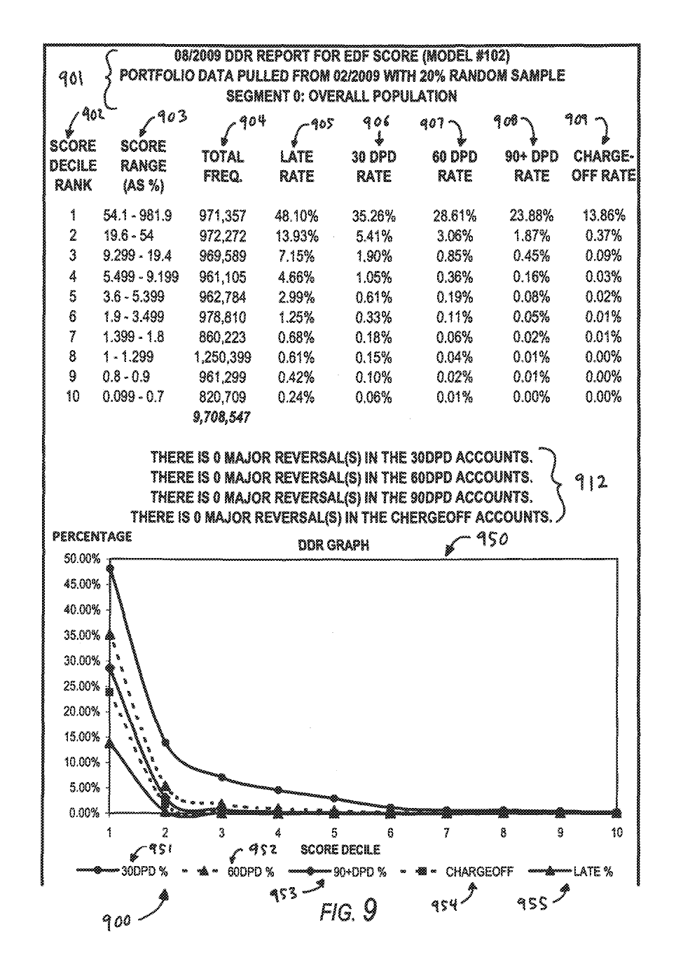

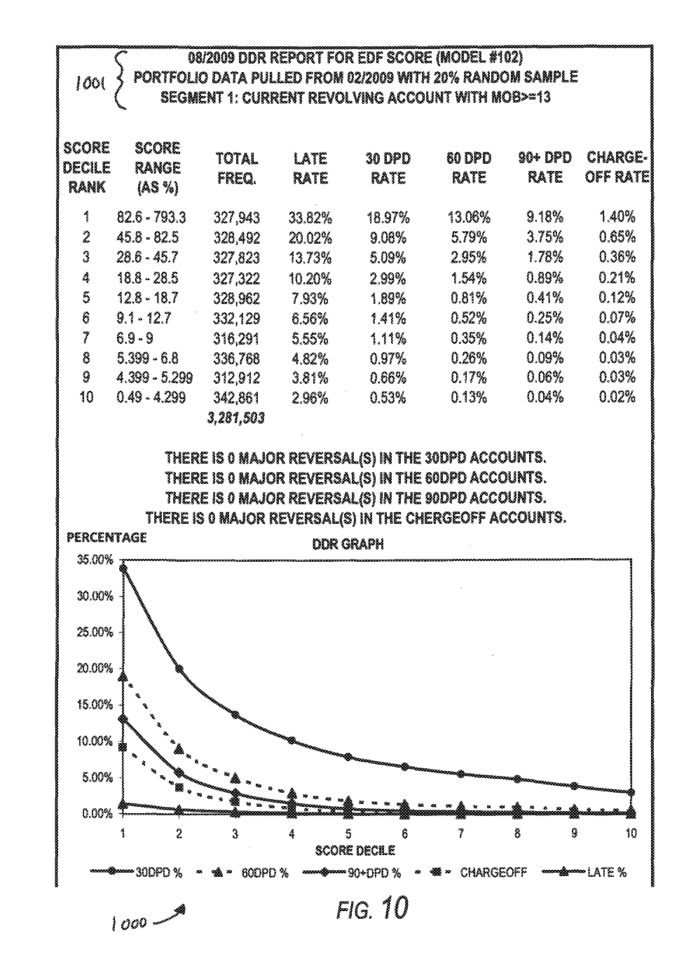

For example, FIGS. 9-16 provide sample overview, overall, and segment level validation reports for several other metrics. More particularly, FIG. 9 illustrates an example validation report 900 showing the results of a particular example Dynamic Delinquency Report validation for a particular example model applied to the overall population according to one or more illustrative aspects described herein. The header 901 is similar to the headers described above for the other reports, but indicates that the report is a DDR and uses a six-month performance window and works from a 20% random population sample. The report includes a table showing score decile rank 902 and, for each score decile rank 902, provides a score range 903, total frequency 904, late rate 905 (percentage of accounts where debt payment is late), 30 DPD rate 906 (percentage of accounts where the debt payment is 30-59 days-past-due), 60DPD rate 907 (percentage of accounts where the debt payment is 60-89 days-past-due), 90+ DPD rate 908 (percentage of accounts where the debt payment is greater than or equal to 90 days-past-due), and charge-off rate 909 (percentage of accounts where the debt has been charged-off).

The DDR report 900 also includes a notification 912 of any major reversals in the different groups of delinquent accounts. The report 900 also includes a DDR graph 950 plotting 30 DPD % 951, 60 DPD % 952, 90+DPD % 953, chargeoff % 954, and late % 955 versus score decile 902.

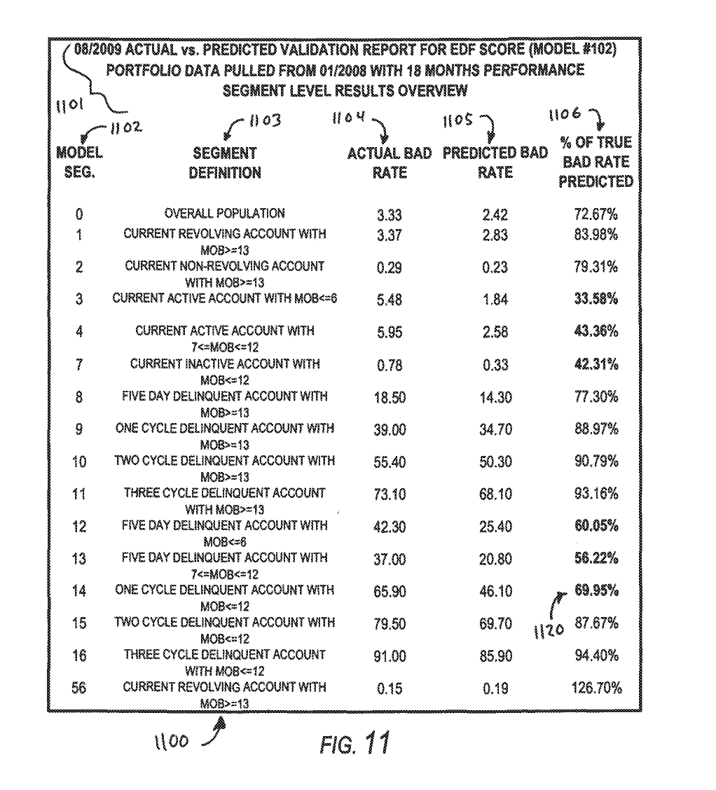

FIG. 10 illustrates an example validation report 1000 showing the results of a particular example Dynamic Delinquency Report validation for a particular example model applied to a first example segment of the population according to one or more illustrative aspects described herein. This report 1000 is similar to report 900 but relates to only one example population segment.

FIG. 11 illustrates an example validation report 1100 showing an overview of the results of a particular example Actual vs. Predicted validation of a particular example model according to one or more illustrative aspects described herein. Similar to the K-S overview report 600 described above, this overview report 1100 includes a header 1101 indicating that it is an Actual vs. Predicted validation report for the EDF score model #102 that uses an eighteen month performance window. Like report 600, this report 1100 also has a table showing the model segment number 1102 and segment definition 1103. This report 1100 presents, for each segment, an actual bad rate 1104 (percentage of the population segment currently considered to be “bad” accounts (e.g., beyond some delinquency threshold)), a predicted bad rate 1105 (percentage of population segment that was predicted during model development to be “bad”), and percentage of actual bad accounts predicted by the model 1106. In this example, any percentage 1106 below a 70% threshold value is highlighted to alert the report reader of less than optimal performance of the model in certain population segments. For example percentage 1120 is highlighted and shows that 69.5% of the bad accounts in this population segment were predicted by model #102.

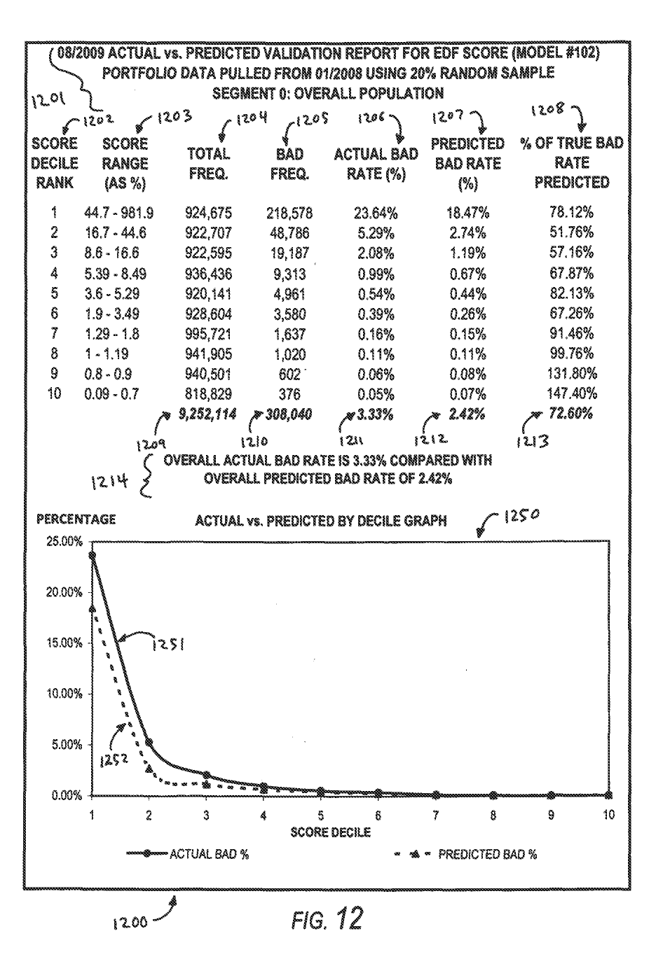

FIG. 12 illustrates an example validation report 1200 showing the results of a particular example Actual vs. Predicted validation for a particular example model applied to the overall population according to one or more illustrative aspects described herein. More particularly, FIG. 12 illustrates an example validation report 1200 showing the results of a particular example Actual vs. Predicted validation for a particular example model applied to the overall population according to one or more illustrative aspects described herein. The header 1201 is similar to the headers described above for the other reports, but indicates that the report 1200 is an Actual vs. Predicted validation report and uses an eighteen month performance window and works from a 20% random sample. The report 1200 includes a table showing score decile rank 1202 and, for each score decile rank 1202, a score range 1203, total frequency 1204, bad frequency 1205, actual bad rate 1206, predicted bad rate 1207, and percentage of actual bad accounts predicted by the model 1208. The report 1200 also includes totals 1209, 1210, 1211, 1212, and 1213. The report 1200 also includes a comparison 1214 of the total actual bad rate 1211 with the total predicted bad rate 1212. The report 1200 also includes a Decile Graph 1250 plotting actual bad percentage 1251 and predicted bad percentage 1252 versus score decile 1202.

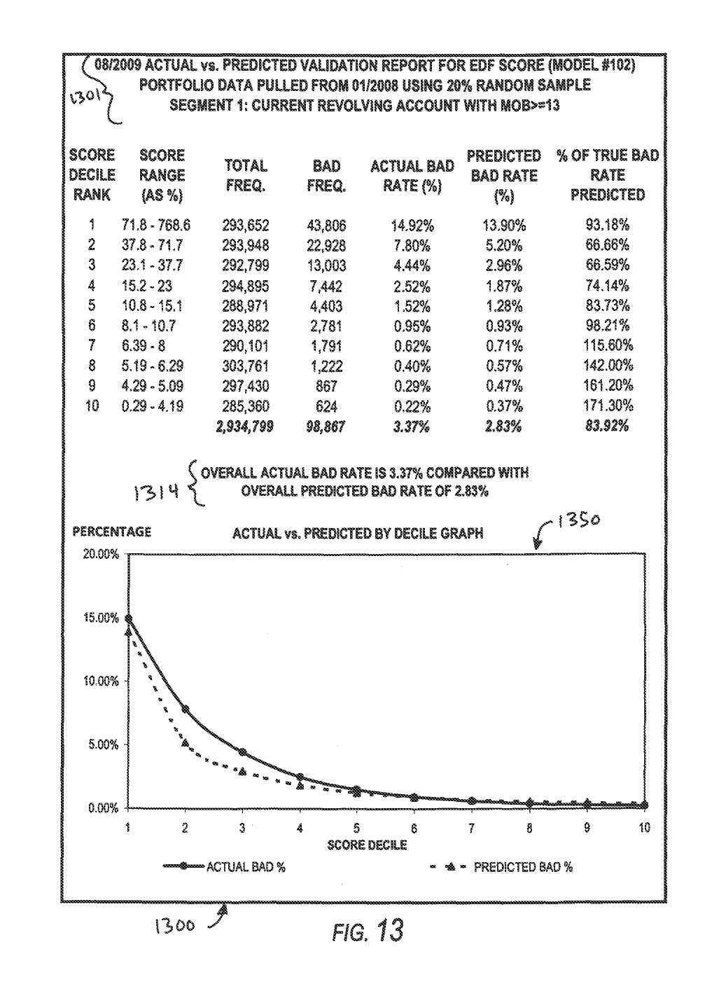

FIG. 13 illustrates an example validation report 1300 showing the results of a particular example Actual vs. Predicted validation for a particular example model applied to a first example segment of the population according to one or more illustrative aspects described herein. This report 1300 is similar to report 1200 but relates to only one example population segment.

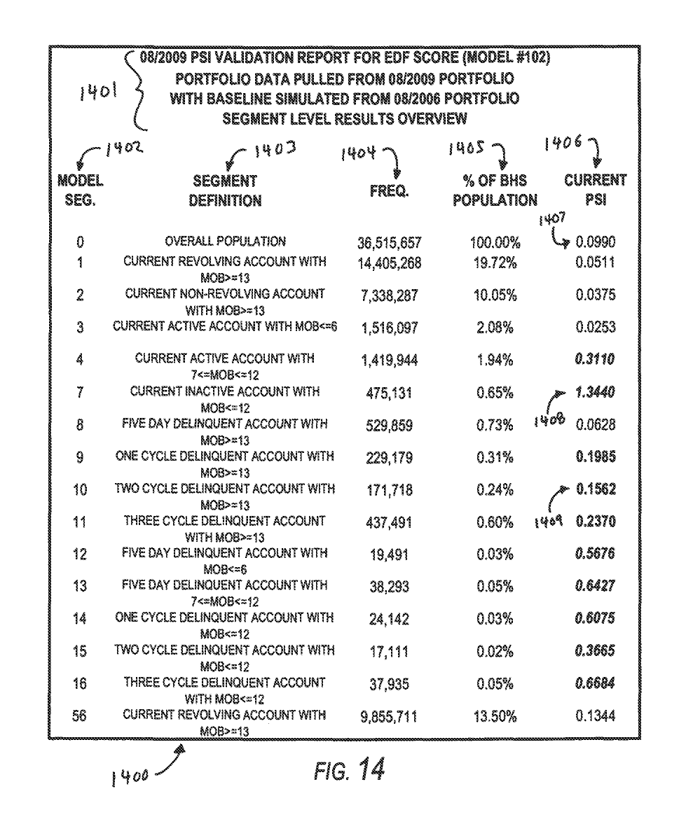

FIG. 14 illustrates an example validation report 1400 showing an overview of the results of a particular example Population Stability Index (PSI) validation of a particular example model according to one or more illustrative aspects described herein. Similar to the K-S overview report 600 described above, this overview report 1400 includes a header 1401 indicating that it is a PSI validation report for the EDF score model #102. The header 1401 also indicates that data from August 2009 is compared to baseline (i.e., benchmark) data simulated from August 2006. Like report 600, this report 1400 also has a table showing the model segment number 1402 and segment definition 1403. This report 1400 presents, for each segment, a frequency 1404 (number of accounts in the population segment), percent of baseline simulation population represented by the segment 1405, and PSI value 1406. In this example, any PSI value 1406 between 0.15 and 0.30, such as value 1409 are shown in the report in bold to alert the report reader of populations where there is at least some population shift that may be significant. Furthermore, any PSI value 1406 greater than 0.30 is shown in bold and italics to alert the report reader of any significant population shifts.

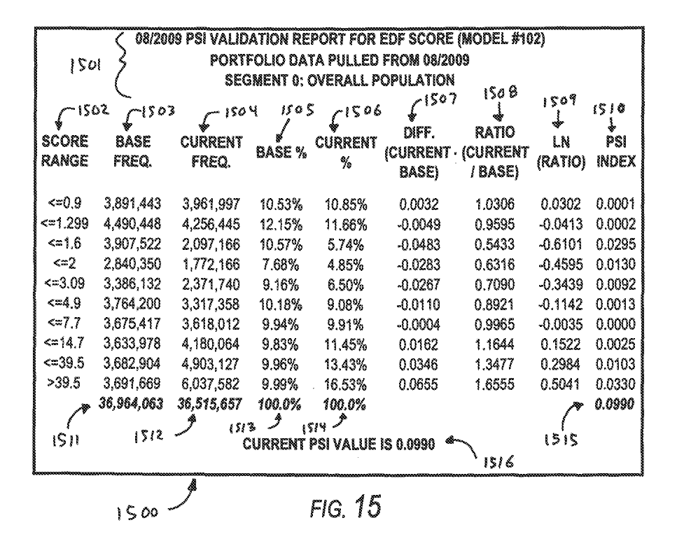

FIG. 15 illustrates an example validation report 1500 showing the results of a particular example Population Stability Index validation for a particular example model applied to the overall population according to one or more illustrative aspects described herein. Similar to other reports, the report 1500 includes a header 1501 and a score range 1502. For each score range 1502, the report includes a base frequency 1502 (number of accounts in score range in baseline simulation), current frequency 1504 (number of accounts in score range currently), base percentage 1505, current percentage 1506, difference between the current and base percentages 1507, ratio of the current to base percentages 1508, natural log of the ratio 1509, and PSI value 1510 (PSI=1n(current %/benchmark %)×(current %−benchmark %)). Total values 1511, 1512, 1513, 1514, and 1515 are also shown as is a notification 1516 of the current PSI value 1515.

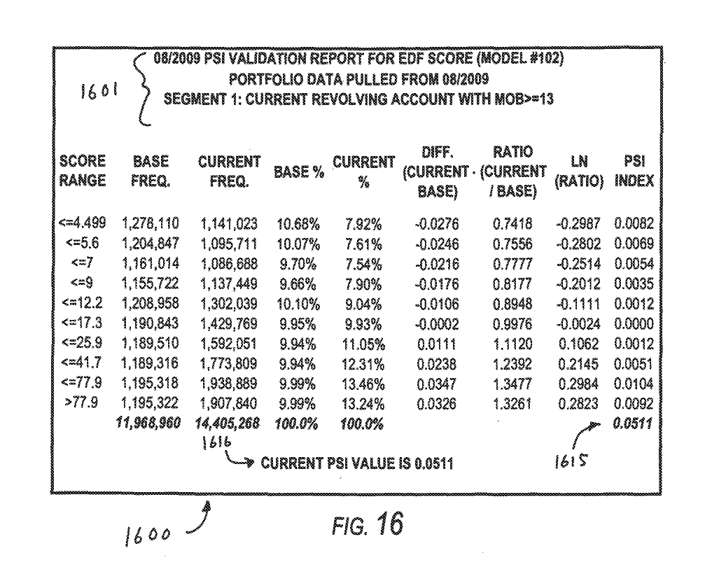

FIG. 16 illustrates an example validation report 1600 showing the results of a particular example Population Stability Index validation for a particular example model applied to a first example segment of the population according to one or more illustrative aspects described herein. This report 1600 is similar to report 1500 but relates to only one example population segment.

As will be appreciated by one of skill in the art, aspects of the disclosure may be embodied as a method (e.g., a computer-implemented process, a business process, or any other process), apparatus (including a device, machine, system, computer program product, and/or any other apparatus), or a combination of the foregoing. Accordingly, embodiments may take the form of an entirely hardware embodiment, an entirely software embodiment (including firmware, resident software, micro-code, etc.), or an embodiment combining software and hardware aspects that may generally be referred to herein as a “system.” Furthermore, embodiments may take the form of a computer program product on a computer-readable medium having computer-usable program code embodied in the medium.

Any suitable computer readable medium may be utilized. The computer readable medium may be, for example but not limited to, an electronic, magnetic, optical, electromagnetic, infrared, or semiconductor system, apparatus, device, or medium. More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments may be written in an object oriented, scripted or unscripted programming language such as Java, Perl, Smalltalk, C++, or the like. However, the computer program code for carrying out operations of embodiments may also be written in conventional procedural programming languages, such as the “C” programming language or similar programming languages.

Embodiments are described hereinabove with reference to flowchart illustrations and/or block diagrams of methods, apparatuses (systems), and computer program products and with reference to a number of sample validation reports generated by the methods, apparatuses (systems), and computer program products. It will be understood that each block of the flowchart illustrations and/or block diagrams, and/or combinations of blocks in the flowchart illustrations and/or block diagrams, as well as procedures described for generating the validation reports, can be implemented by computer program instructions. These computer program instructions may be provided to a processor of a general purpose computer, special purpose computer, or other programmable data processing apparatus to produce a particular machine, such that the instructions, which execute via the processor of the computer or other programmable data processing apparatus, create means for implementing the functions/acts specified in the flowchart, block diagram block or blocks, and/or written description.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart, block diagram block(s), and/or written description.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart, block diagram block(s), and/or written description. Alternatively, computer program implemented steps or acts may be combined with operator or human implemented steps or acts in order to carry out an embodiment.

While certain exemplary embodiments have been described and shown in the accompanying drawings, it is to be understood that such embodiments are merely illustrative of and not restrictive on the broad disclosure, and that this disclosure should not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, various aspects of the disclosure may be practiced other than as specifically described herein. For example, unless expressly stated otherwise, the steps of processes described herein may be performed in orders different from those described herein and one or more steps may be combined, split, or performed simultaneously. Those skilled in the art will appreciate, in view of this disclosure, that different embodiments described herein may be combined to form other embodiments.

### II. Automated Recalibration of Risk Models

As noted above, it is possible that over time, risk scoring models used by an organization, such as a financial institution, may deteriorate. Thus, various methods, systems, apparatuses, and computer-readable media for automatically recalibrating such models will now be described.

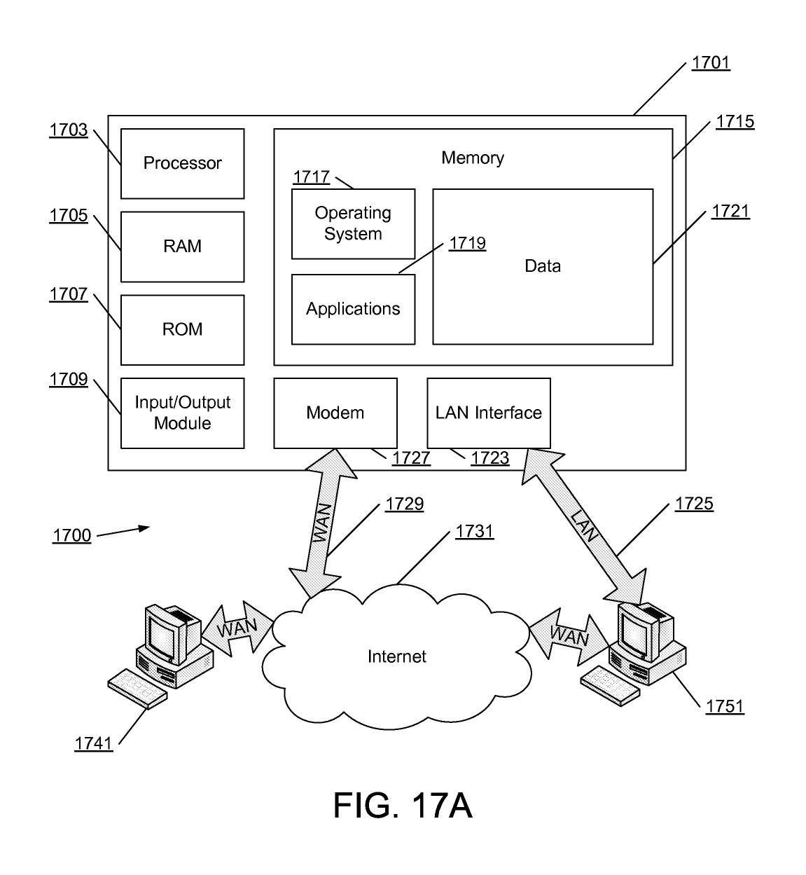

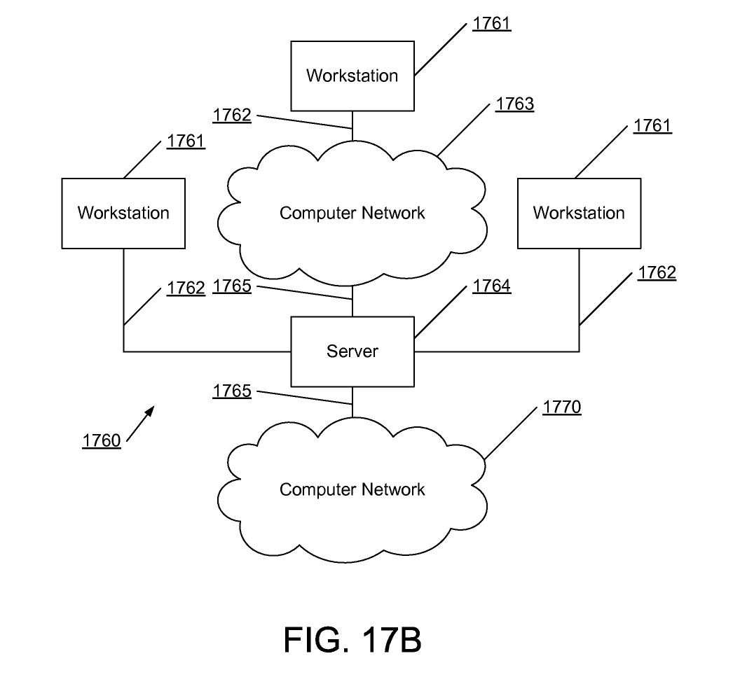

FIG. 17A illustrates an example block diagram of a generic computing device 1701 (e.g., a computer server) in an example computing environment 1700 that may be used according to one or more illustrative embodiments of the disclosure. The generic computing device 1701 may have a processor 1703 for controlling overall operation of the server and its associated components, including random access memory (RAM) 1705, read-only memory (ROM) 1707, input/output (I/O) module 1709, and memory 1715.

I/O module 1709 may include a microphone, mouse, keypad, touch screen, scanner, optical reader, and/or stylus (or other input device(s)) through which a user of generic computing device 1701 may provide input, and may also include one or more of a speaker for providing audio output and a video display device for providing textual, audiovisual, and/or graphical output. Software may be stored within memory 1715 and/or other storage to provide instructions to processor 1703 for enabling generic computing device 1701 to perform various functions. For example, memory 1715 may store software used by the generic computing device 1701, such as an operating system 1717, application programs 1719, and an associated database 1721. Alternatively, some or all of the computer executable instructions for generic computing device 1701 may be embodied in hardware or firmware (not shown).

The generic computing device 1701 may operate in a networked environment supporting connections to one or more remote computers, such as terminals 1741 and 1751. The terminals 1741 and 1751 may be personal computers or servers that include many or all of the elements described above with respect to the generic computing device 1701. The network connections depicted in FIG. 17A include a local area network (LAN) 1725 and a wide area network (WAN) 1729, but may also include other networks. When used in a LAN networking environment, the generic computing device 1701 may be connected to the LAN 1725 through a network interface or adapter 1723. When used in a WAN networking environment, the generic computing device 1701 may include a modem 1727 or other network interface for establishing communications over the WAN 1729, such as the Internet 1731. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Generic computing device 1701 and/or terminals 1741 or 1751 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

FIG. 17B illustrates another example operating environment in which various aspects of the disclosure may be implemented. As illustrated, system 1760 may include one or more workstations 1761. Workstations 1761 may, in some examples, be connected by one or more communications links 1762 to computer network 1763 that may be linked via communications links 1765 to server 1764. In system 1760, server 1764 may be any suitable server, processor, computer, or data processing device, or combination of the same. Server 1764 may be used to process the instructions received from, and the transactions entered into by, one or more participants.

According to one or more aspects, system 1760 may be associated with a financial institution, such as a bank. Various elements may be located within the financial institution and/or may be located remotely from the financial institution. For instance, one or more workstations 1761 may be located within a branch office of a financial institution. Such workstations may be used, for example, by customer service representatives, other employees, and/or customers of the financial institution in conducting financial transactions via network 1763. Additionally or alternatively, one or more workstations 1761 may be located at a user location (e.g., a customer's home or office). Such workstations also may be used, for example, by customers of the financial institution in conducting financial transactions via computer network 1763 or computer network 1770.

Computer network 1763 and computer network 1770 may be any suitable computer networks including the Internet, an intranet, a wide-area network (WAN), a local-area network (LAN), a wireless network, a digital subscriber line (DSL) network, a frame relay network, an asynchronous transfer mode network, a virtual private network (VPN), or any combination of any of the same. Communications links 1762 and 1765 may be any communications links suitable for communicating between workstations 1761 and server 1764, such as network links, dial-up links, wireless links, hard-wired links, etc.

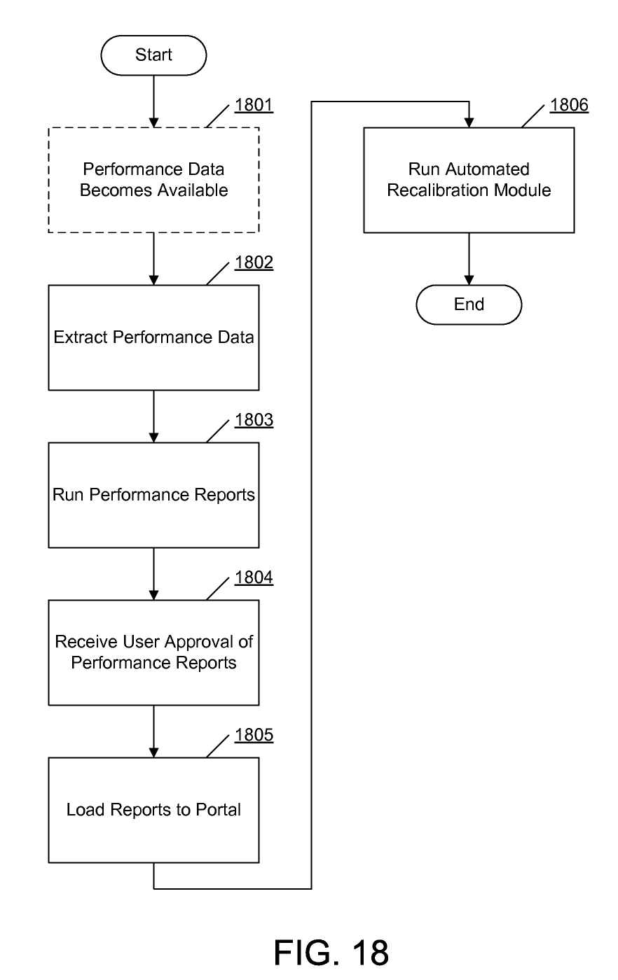

FIG. 18 illustrates a method of automatically validating one or more risk models according to one or more illustrative aspects described herein. According to one or more aspects, the methods described herein may be implemented by software executed on one or more computers, such as the generic computing device 1701 of FIG. 17A, and/or by a computing system, such as system 1760 of FIG. 17B. In at least one arrangement, the methods described herein may be performed by and/or in combination with a server (e.g., server 1764). Additionally or alternatively, the methods described herein may be performed by and/or in combination with one or more workstations (e.g., workstations 1761).

In step 1801, performance data may become available. For example, a financial institution may internally publish (e.g., to an electronically accessible database, such as a database stored on server 1764), on a monthly basis, information describing and/or otherwise relating to transactions processed by the financial institution and/or conducted by customers of the financial institution during the previous month. This information may be referred to as “performance data” and may be indicative of a plurality of events and/or trends. Additionally or alternatively, the performance data may include information about one or more customer accounts. For instance, the performance data may include information about one or more customer credit card accounts, customer debit card accounts, customer home loan accounts, and/or other types of accounts provided by the financial institution. Among other things, this performance data may also include information about delinquent accounts, such as customer credit card accounts where the accountholder customer has fallen behind on payments owed to the financial institution. As further described below, by gathering and analyzing this information, the financial institution may be able to model trends in customer behavior and thus may be able to better predict a variety of different outcomes (e.g., expected profits, losses, capitalization, risk, etc.), which in turn may be useful to the financial institution in making business decisions. For example, if a financial institution can predict the number of credit card accounts that will be delinquent in payment in the coming month, the financial institution may be able to prospectively estimate its expected revenues and/or losses with respect to the credit card accounts that the financial institution services. In at least one arrangement, the performance data may include portfolio data 110 (described above).

In step 1802, the performance data may be extracted. For example, in step 1802, a computing device implementing one or more aspects of the disclosure (e.g., computing device 1701) may access a database in which the published performance data is stored (e.g., in data server 210). In addition, the computing device may download and/or otherwise receive the published performance data so that the computing device may analyze the data and/or use the data in generating one or more model validation reports.

In step 1803, one or more performance reports may be run. For example, in step 1803, the computing device may generate one or more model validation reports, such as Population Stability Index (PSI) validation reports, Kolmogorov-Smirnov (K-S) validation reports, and/or other types of model validation reports based on the extracted performance data, as discussed in greater detail above.

In step 1804, user approval of the one or more performance reports may be received. For example, in step 1804, the computing device may display one or more of the generated reports to a user, such as an associate of a financial institution implementing one or more aspects of the disclosure, who may be responsible for model validation, and who may thus be responsible for reviewing and/or approving the one or more reports. In one or more arrangements, such user approval may be received by the computing device as electronic user input via a graphical user interface displayed by the computing device. In reviewing and/or approving such reports, the user may, for instance, evaluate the reports to determine whether they are complete and/or whether they include errors.

In step 1805, the one or more approved performance reports may be uploaded to a portal. For example, once user approval of the one or more performance reports is received, the computing device may upload the generated performance reports to a web portal where these reports may be accessed by one or more users, such as management personnel and/or other stakeholders within the financial institution who may review and/or rely on such reports in making business decisions with respect to the financial institution. In one or more arrangements, such a web portal may implement HTML, CSS, JavaScript, and/or other web technologies, so as to provide a convenient and easy-to-use user interface for reviewing the model validation reports.

In step 1806, an automated recalibration module may be run. For example, in step 1806, the computing device may perform one or more methods (such as those described in greater detail below) to recalibrate and/or otherwise adjust the one or more models so that these models more accurately reflect and/or predict the performance data. This automated recalibration process may, for example, allow a financial institution implementing one or more aspects of the disclosure to more accurately model trends that change over time. For instance, as a result of macro-level changes in the U.S. and/or global economies, a changing percentage of credit card accountholders may be expected to be delinquent in making payments owed to the financial institution. By recalibrating the one or more models that predict this percentage, the financial institution may be able to more accurately forecast its revenue, profit, loss, capitalization, and/or other concerns.

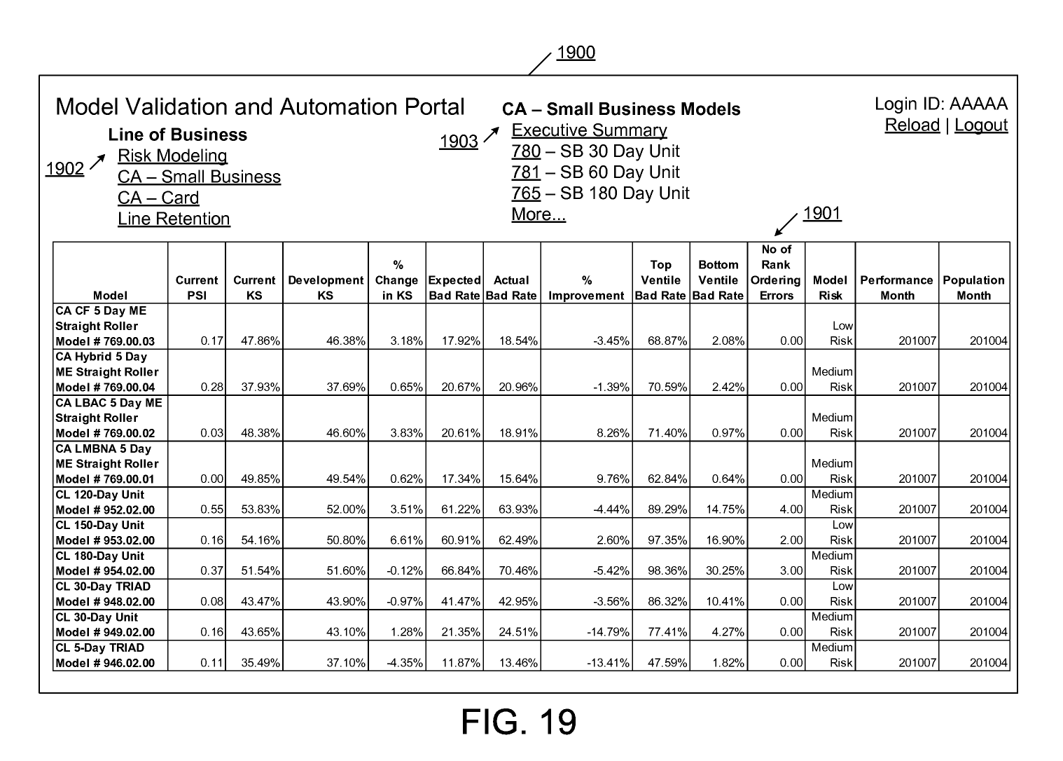

FIG. 19 illustrates an example of a user interface that includes a risk model validation report according to one or more illustrative aspects described herein. For example, user interface 1900 may include a model validation summary report 1901.

As seen in FIG. 19, model validation summary report 1901 may include a variety of model validation statistics for a plurality of different models. These model validation statistics may include, for instance, the current PSI value for the model, the current K-S value for the model, the K-S value of the model at the time the model was first developed, the percentage change in the K-S value (e.g., the percentage change in the K-S value for the model between the development K-S value and the current K-S value), the expected “bad” rate, the actual “bad” rate, the percentage improvement in the “bad” rate from the expected “bad” rate to the actual “bad” rate, the “bad” rate in the top ventile of accounts analyzed by the model, the “bad” rate in the bottom ventile of accounts analyzed by the model, the number of rank ordering errors (e.g., if the model is predicting the likelihood of delinquency with respect to various accounts, a distribution report associated with the model should show the percentage of delinquent accounts increasing as the scores associated with such accounts increases, and the number of rank ordering errors may indicate the number of instances where this is not the case), the level of risk associated with the model (e.g., models that have potential customer impact, such as those used in underwriting, may be classified as “High Risk,” while other models may be classified as “Medium Risk” or “Low Risk” depending on their particular potential impacts), the performance month for the model (e.g., the current month in which the model validation reports have been generated), and/or the population month for the model (e.g., the most recent month for which performance data is available to the model validation processes).

In one or more arrangements, user interface 1900 also may include a line of business menu 1902 that allows a user to view a model validation summary report and/or other model validation reports for one or more models associated with other lines of business (and/or other internal divisions) of the financial institution. Additionally or alternatively, user interface 1900 also may include a model selection menu 1903 via which a user may select one or more model validation summary reports and/or other model validation reports (e.g., for other models) to be displayed.

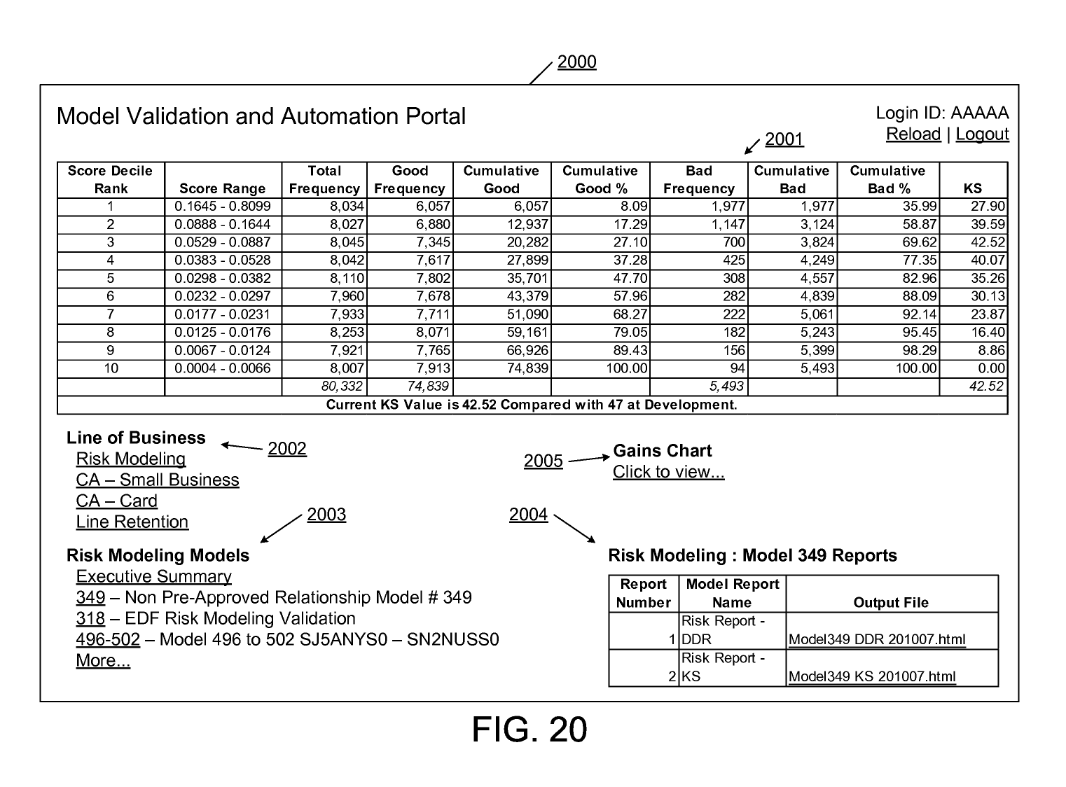

FIG. 20 illustrates another example user interface that includes a risk model validation report according to one or more illustrative aspects described herein. As may be seen in FIG. 20, user interface 2000 may include a model validation report 2001, which may include a variety of different model validation statistics associated with a particular model. For example, for each score decile rank associated with the model, the model validation report 2001 may include a score range (e.g., the range of scores that fall within the corresponding score decile), a total frequency value, a good frequency value, a cumulative good value, a cumulative good percentage value, a bad frequency value, a cumulative bad value, a cumulative bad percentage value, and/or a K-S value. These values may be defined in a similar manner to the similarly-named values discussed above with respect to FIGS. 5-16. Additionally or alternatively, the model validation report 2001 may include a comparison of the current overall K-S value to the K-S value at the time the model was first developed.

In at least one arrangement, user interface 2000 also may include a line of business menu 2002 and a model selection menu 2003, which may function similar to line of business menu 1902 and model selection menu 1903, respectively, as described above. User interface 2000 further may include a report selection menu 2004, via which a user may select one or more model validation reports (e.g., a DDR report, a K-S report, a PSI report, etc.) to be displayed with respect to a particular model, such as the model for which the model validation report 2001 is currently being displayed. User interface 2000 also may include a gains chart 2005 (or a user-selectable link to such a chart, as seen in FIG. 20) in which the K-S values for the model may, for instance, be plotted over the range of score deciles. Other model validation statistics may likewise be plotted in gains chart 2005 in place of, or in addition to, these K-S values for the model.

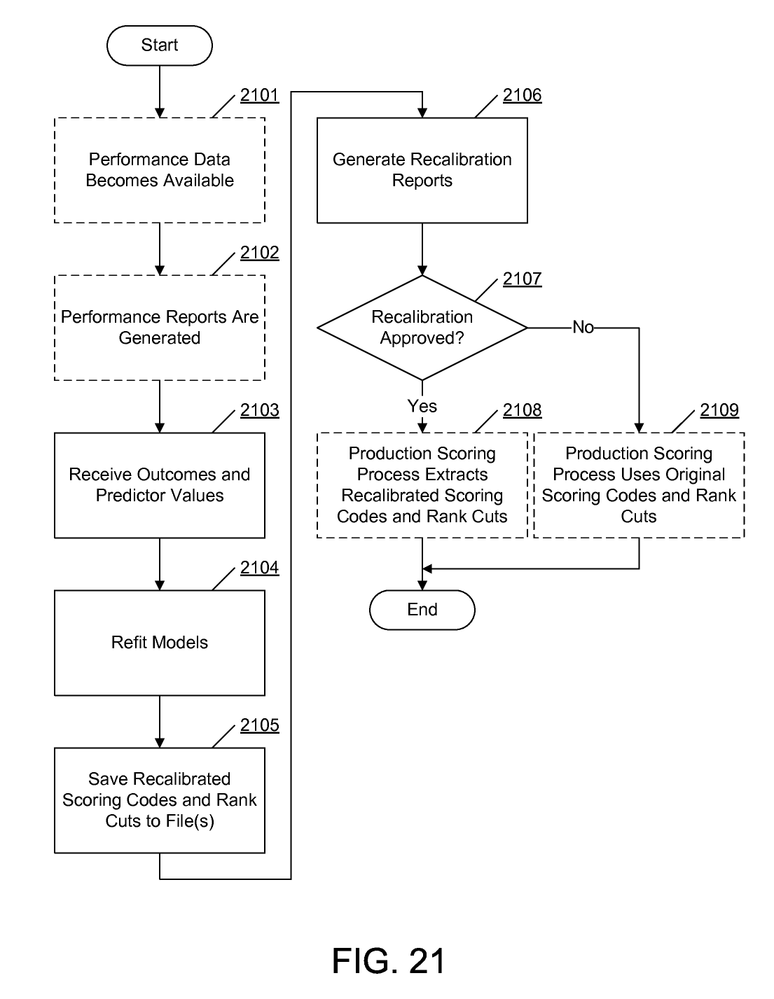

FIG. 21 illustrates a method of automatically recalibrating one or more risk models according to one or more illustrative aspects described herein. In step 2101, performance data may become available. For example, in step 2101, a financial institution may internally publish account performance information, as described above with respect to step 1801.

In step 2102, one or more performance reports may be generated. For example, in step 2102, a computing device (e.g., a computing device associated with the financial institution) may generate one or more model validation reports, such as PSI validation reports, K-S validation reports, and/or other types of model validation reports, as described above with respect to step 1803.

In step 2103, outcomes and predictor values may be received. For example, in step 2103, the computing device may receive outcomes and predictor values, such as one or more model scores associated with the model that represent the final value products of the model.

In step 2104, one or more models may be refit. As used herein, the term “refit” may be used interchangeably with the term “recalibrated.” For example, in step 2104, the computing device may calculate the updated coefficient values, scoring codes, rank cuts, and quality control reports (e.g., model validation reports like K-S validation reports, PSI validation reports, etc.) for the particular model being recalibrated. According to one or more aspects, the computing device may determine the updated coefficient values for the model based on the performance data by modifying the coefficient values of the model so that the model more closely fits a logistic regression of the performance data. Such a logistic regression may provide and/or may be used to predict the probability of occurrence of an event (e.g., whether or not a particular event will occur, such as whether or not a particular account will be delinquent) by fitting data, such as the performance data, to a logic function and/or logistic curve. The computing device then may determine the scoring codes and rank cuts by dividing up the range of data into deciles (e.g., ten levels), ventiles (e.g., twenty levels), or other units, as desired. In one or more arrangements, the ways in which a range of data may be divided up or “binned” may vary, but model scores typically may be divided up into ranges of data. Subsequently, the computing device may generate updated quality control reports for the recalibrated model, such as PSI validation reports, K-S validation reports, and/or other model validation reports.

In step 2105, the recalibrated scoring codes and rank cuts may be saved to one or more files. For example, the computing device may be programmed to calculate the results of one or more models and/or generate one or more model validation reports based on variable definitions stored in one or more configuration files. Thus, in step 2105, the one or more configuration files may be updated so that the computing device may use the recalibrated coefficients, scoring codes, and rank cuts in modeling the data and/or in validating the models.

In step 2106, one or more recalibration reports may generated. For example, in step 2106, the computing device may generate one or more PSI validation reports, K-S validation reports, and/or other types of validation reports for the recalibrated model. Using these recalibrated model validation reports, the financial institution may be able to determine whether the recalibrated model more accurately models the performance data than the original (e.g., non-recalibrated) model. As described below, it may be determined that the recalibrated model more accurately models the performance data than the original, unmodified model when the recalibrated model has a lower overall PSI value, when the recalibrated model captures more “bad” accounts, and/or when the recalibrated model has a higher overall K-S value.

In step 2107, it may be determined whether the recalibration has been approved. For example, in step 2107, the computing device may display the recalibrated model validation reports generated in the previous step to a user via a user interface, and subsequently, the computing device may prompt the user to approve the recalibrated model. According to one or more aspects, the user may decide to approve the recalibrated model based on whether the recalibrated model more accurately models the performance data, as indicated by the factors noted above (e.g., lower overall PSI value, more “bad” accounts captured, higher overall K-S value, etc.). In one or more alternative arrangements, user input might not be required to approve the recalibration, and the computing device may automatically decide whether to approve and implement the recalibrated model (e.g., based on the recalibrated model having a lower overall PSI value, based on the recalibrated model capturing more “bad” accounts, and/or based on the recalibrated model having a higher overall K-S value).

If the recalibration is approved in step 2107, then in step 2108, the production scoring process (e.g., another computing device or server implementing a scoring process or method that gathers, analyzes, and outputs performance data, such as model server 260 and/or validator 230) may extract the recalibrated scoring codes and rank cuts for use in the upcoming month's modeling calculations. For example, a server or other computing device that implements the scoring process may communicate with the computing device that refit the models (or otherwise access data provided by the computing device that refit the models) to obtain the newly updated coefficients, scoring codes, and/or rank cuts for the one or more recalibrated models.

On the other hand, if the recalibration is not approved in step 2107, then in step 2109, the production scoring process may continue to use the original coefficients, scoring codes, and rank cuts. In some instances, the recalibration may be approved with respect to some models but not others, and in these cases, the production scoring process may extract the updated coefficients, scoring codes, and rank cuts for the recalibrated models, and continue to use the original coefficients, scoring codes, and rank cuts for the modules for which recalibration is not approved.

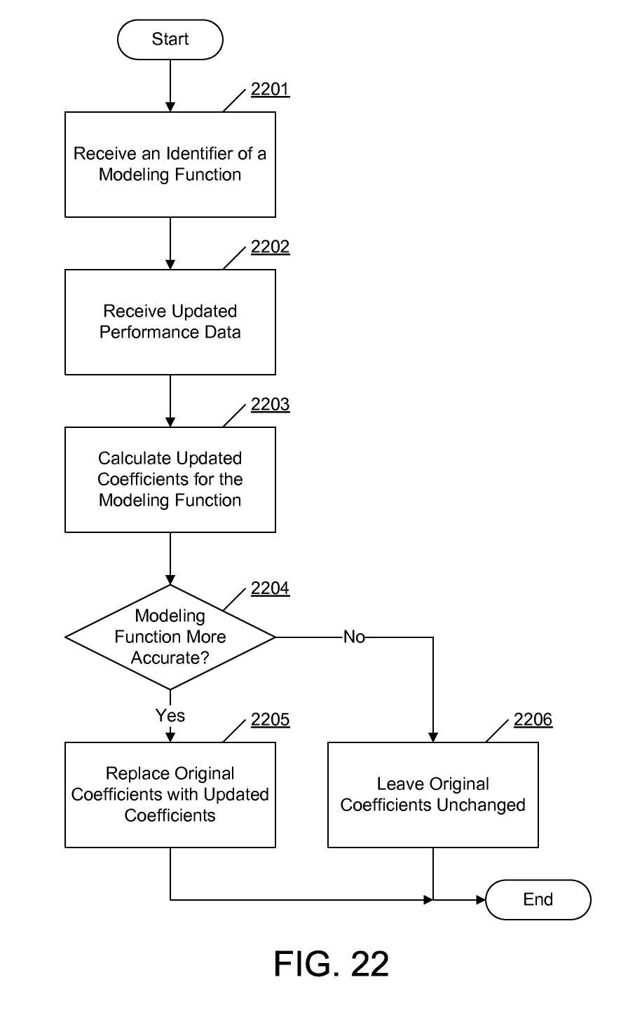

FIG. 22 illustrates a method of automatically recalibrating a risk model according to one or more illustrative aspects described herein. More specifically, in FIG. 22, the steps that a computing device may perform in recalibrating a particular risk scoring model may be seen in greater detail.

For example, in step 2201, a computing device may receive an identifier of a modeling function to be recalibrated. The identifier may be a name of the model, a unique identification number and/or string, and/or some other associated handle by which the computing device may identify and/or access information related to the model. In one or more arrangements, the identifier may be received via a graphical user interface displayed by the computing device (e.g., in response to a user selecting the identified model for recalibration).

In step 2202, the computing deice may receive updated performance data which may subsequently be used by the computing device in recalibrating the model. For example, the computing device may receive updated performance data by accessing a database (e.g., stored on data server 210) where performance data is stored. Such performance data may be similar to the performance data made available in step 2101 (described above).

In step 2203, the computing device may calculate one or more updated coefficients for the modeling function. As noted above, to calculate updated coefficients for a modeling function, the computing device may, for example, modify the coefficient values of the modeling function so that the model more closely fits a logistic regression of the performance data.

In step 2204, the computing device may determine whether the recalibrated modeling function is more accurate than the original, unmodified modeling function. To determine this, the computing device may generate one or more model validation reports for the recalibrated modeling function and compare these reports to the model validation reports for the original, unmodified modeling function.

For example, the computing device may generate a PSI validation report for the recalibrated model. Subsequently, the computing device may determine that the recalibrated modeling function is more accurate than the original, unmodified modeling function if the recalibrated modeling function has a lower overall PSI value than the original, unmodified modeling function. Alternatively, if the computing device determines that the original, unmodified modeling function has a lower overall PSI value than the recalibrated modeling function, the computing device may determine that the original, unmodified modeling function is more accurate than the recalibrated modeling function.

As another example, the computing device may generate a K-S validation report for the recalibrated model. Subsequently, the computing device may determine that the recalibrated modeling function is more accurate than the original, unmodified modeling function if the recalibrated modeling function has a greater overall K-S value than the original, unmodified modeling function. Alternatively, if the computing device determines that the original, unmodified modeling function has a greater overall K-S value than the recalibrated modeling function, the computing device may determine that the original, unmodified modeling function is more accurate than the recalibrated modeling function.

In still another example, the computing device may generate a DDR validation report for the recalibrated model. Subsequently, the computing device may determine that the recalibrated modeling function is more accurate than the original, unmodified modeling function if the recalibrated modeling function captures a higher percentage of “bad” accounts than the original, unmodified modeling function. Alternatively, if the computing device determines that the original, unmodified modeling function captures a higher percentage of “bad” accounts than the recalibrated modeling function, the computing device may determine that the original, unmodified modeling function is more accurate than the recalibrated modeling function.

In some arrangements, only one of these model validation reports might be generated and alone might serve as the basis for making the determination of whether the recalibrated model is more accurate than the original, unmodified model. In other arrangements, two or more validation reports may be generated and compared in determining whether the recalibrated model is more accurate than the original, unmodified model.

If it is determined, in step 2204, that the recalibrated modeling function is more accurate than the original, unmodified modeling function, then in step 2205, the computing device may replace the original, unmodified coefficients with the recalibrated coefficients. For example, the computing device may updated and/or overwrite one or more configuration files and/or database entries in which such coefficients are stored (e.g., in validator 230 and/or model server 260). On the other hand, if it is determined, in step 2204, that the original, unmodified modeling function is more accurate than the recalibrated modeling function, then in step 2206, the computing device may leave the original, unmodified coefficients unchanged.

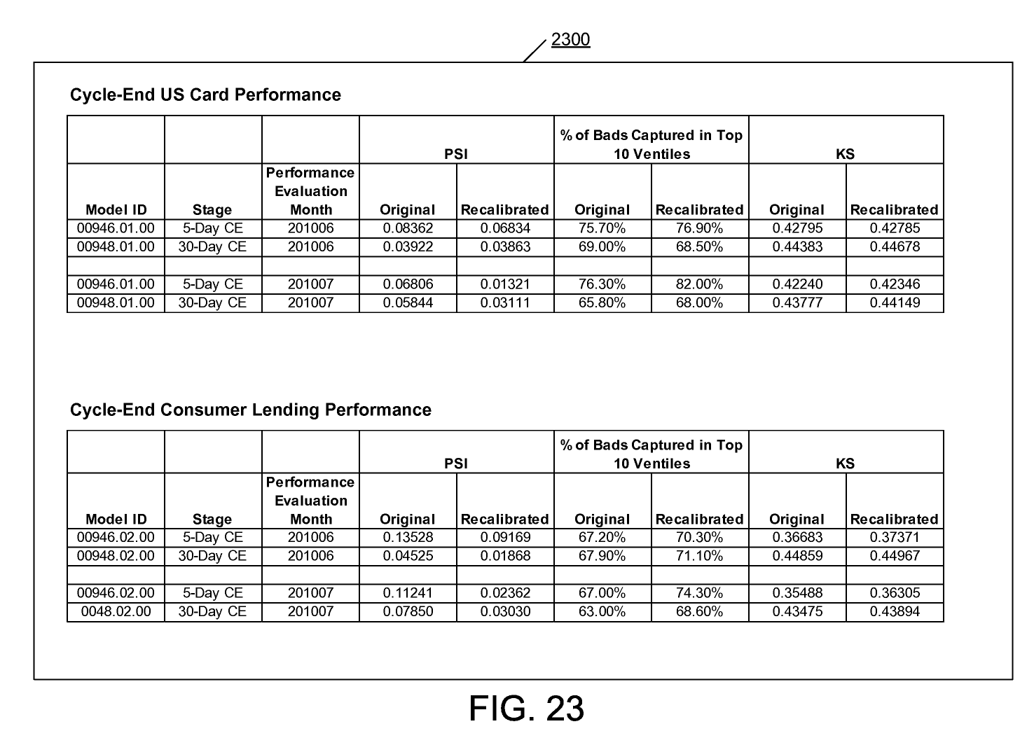

FIG. 23 illustrates an example of a user interface that includes risk model recalibration reports according to one or more illustrative aspects described herein. As may be seen in FIG. 23, user interface 2300 may include a plurality of model validation statistics for various models that have been recalibrated. Among other things, the statistics displayed via user interface 2300 may include, for each of the one or more models, the particular model's identifier, the model's stage, the model's performance evaluation month (e.g., the month for which the model is predicting outcomes), the model's original overall PSI value, the model's recalibrated overall PSI value, the model's original percentage of “bad” accounts captured in the top ten ventiles, the model's original overall K-S value, and/or the model's recalibrated overall K-S value. In one or more alternative arrangements, other model validation statistics may be included in user interface 2300 in place of, and/or in addition to, any and/or all of those noted above.

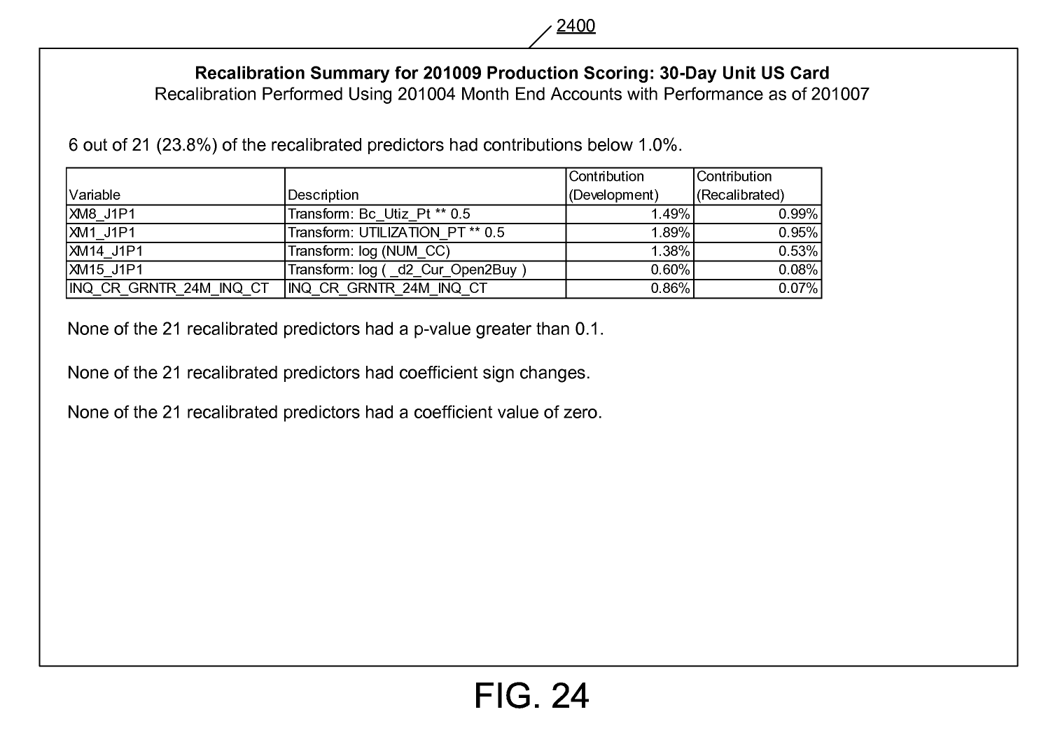

FIG. 24 illustrates an example of a user interface that includes a risk model recalibration report according to one or more illustrative aspects described herein. As may be seen in FIG. 24, user interface 2400 may include a variety of information about a modeling function that has been recalibrated. For example, user interface 2400 may include an indication of how many of the recalibrated predictors had contributions below one percent. Additionally or alternatively, user interface 2400 may include indications of how many of the recalibrated predictors had a p-value greater than 0.1, how many of the recalibrated predictors had coefficient sign changes, and/or how many of the recalibrated predictors had a coefficient value of zero. According to one or more aspects, it may be determined (e.g., by a computing device) that a particular recalibrated predictor is no longer significant to a particular model and/or the modeling process if the recalibrated predictor has a contribution of less than one percent, if the recalibrated predictor has a p-value greater than 0.1, if the recalibrated predictor has had a coefficient sign change, and/or if the recalibrated predictor has a coefficient value of zero. Thus, the one or more indications included in user interface 2400 may inform a user about how a particular model has generally changed as a result of the model being recalibrated.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, the steps illustrated in the illustrative figures may be performed in other than the recited order, and one or more steps illustrated may be optional in accordance with aspects of the disclosure.

What is claimed is:

1. At least one non-transitory computer-readable medium having computer-executable instructions stored thereon that, when executed, cause at least one processor to:
receive a function definition of a risk model that models risk associated with one or more credit card accounts serviced by a financial institution, the function definition including at least one input variable and a first set of one or more coefficients;
receive portfolio data from a database, the portfolio data being regularly collected by the financial institution, and the portfolio data including at least one input value corresponding to the at least one input variable of the function definition;
determine a second set of one or more coefficients for the function definition by calculating a logistic regression of one or more statistics included in the portfolio data, the one or more statistics being associated with the risk model;
determine whether the risk model captures a higher percentage of actually delinquent accounts when the second set of coefficients is used in conjunction with the function definition instead of the first set of one or more coefficients; and
in response to determining that the risk model captures a higher percentage of actually delinquent accounts when the second set of coefficients is used, replace the first set of one or more coefficients with the second set of one or more coefficients to recalibrate the risk model.

2. A method, comprising:
receiving, by a computing device, a first identifier identifying a modeling function that models performance data, the modeling function having at least one input variable and a first set of one or more coefficients;
receiving, by the computing device, updated performance data from a data source, the updated performance data including at least one input value corresponding to the at least one input variable;
calculating, by the computing device, a second set of one or more coefficients for the modeling function based on the updated performance data;
determining, by the computing device, whether the modeling function more accurately models the updated performance data when the second set of one or more coefficients is used in computing at least one result of the modeling function instead of the first set of one or more coefficients; and
in response to determining that the modeling function more accurately models the updated performance data when the second set of one or more coefficients is used in computing the at least one result, replacing, by the computing device, the first set of one or more coefficients with the second set of one or more coefficients to recalibrate the modeling function.

3. The method of claim 2, wherein determining whether the modeling function more accurately models the updated performance data includes:
computing a first population stability index value for the modeling function using the first set of one or more coefficients;
computing a second population stability index value for the modeling function using the second set of one or more coefficients; and
in response to determining that the second population stability index value is less than the first population stability index value, determining that the modeling function more accurately models the updated performance data when the second set of one or more coefficients is used in computing the at least one result.

4. The method of claim 2, wherein determining whether the modeling function more accurately models the updated performance data includes:
computing a first Kolmogorov-Smirnov (K-S) metric value for the modeling function using the first set of one or more coefficients;
computing a second K-S metric value for the modeling function using the second set of one or more coefficients; and
in response to determining that the second K-S metric value is greater than the first K-S metric value, determining that the modeling function more accurately models the updated performance data when the second set of one or more coefficients is used in computing the at least one result.

5. The method of claim 2, wherein determining whether the modeling function more accurately models the updated performance data includes determining that the modeling function captures a higher percentage of bad accounts when the second set of one or more coefficients is used in computing the at least one result.

6. The method of claim 2, wherein the modeling function is a risk model that quantifies risk associated with one or more credit accounts of a financial institution.

7. The method of claim 2, wherein the modeling function is recalibrated on a monthly basis.

8. The method of claim 2, further comprising:
in response to replacing the first set of one or more coefficients with the second set of one or more coefficients to recalibrate the modeling function, generating, by the computing device, a report indicating that the first set of one or more coefficients has been replaced by the second set of one or more coefficients; and
transmitting, by the computing device, the report to one or more users.

9. At least one non-transitory computer-readable medium having computer-executable instructions stored thereon that, when executed, cause at least one processor to:
receive a first identifier identifying a modeling function that models performance data, the modeling function having at least one input variable and a first set of one or more coefficients;
receive updated performance data from a data source, the updated performance data including at least one input value corresponding to the at least one input variable;
calculate a second set of one or more coefficients for the modeling function based on the updated performance data;
determine whether the modeling function more accurately models the updated performance data when the second set of one or more coefficients is used in computing at least one result of the modeling function instead of the first set of one or more coefficients; and
in response to determining that the modeling function more accurately models the updated performance data when the second set of one or more coefficients is used in computing the at least one result, replace the first set of one or more coefficients with the second set of one or more coefficients to recalibrate the modeling function.

10. The at least one non-transitory computer-readable medium of claim 9, wherein determining whether the modeling function more accurately models the updated performance data includes:
computing a first population stability index value for the modeling function using the first set of one or more coefficients;
computing a second population stability index value for the modeling function using the second set of one or more coefficients; and
in response to determining that the second population stability index value is less than the first population stability index value, determining that the modeling function more accurately models the updated performance data when the second set of one or more coefficients is used in computing the at least one result.

11. The at least one non-transitory computer-readable medium of claim 9, wherein determining whether the modeling function more accurately models the updated performance data includes:
computing a first Kolmogorov-Smirnov (K-S) metric value for the modeling function using the first set of one or more coefficients;
computing a second K-S metric value for the modeling function using the second set of one or more coefficients; and
in response to determining that the second K-S metric value is greater than the first K-S metric value, determining that the modeling function more accurately models the updated performance data when the second set of one or more coefficients is used in computing the at least one result.

12. The at least one non-transitory computer-readable medium of claim 9, wherein determining whether the modeling function more accurately models the updated performance data includes determining that the modeling function captures a higher percentage of bad accounts when the second set of one or more coefficients is used in computing the at least one result.

13. The at least one non-transitory computer-readable medium of claim 9, wherein the modeling function is a risk model that quantifies risk associated with one or more credit accounts of a financial institution.

14. The at least one non-transitory computer-readable medium of claim 9, wherein the modeling function is recalibrated on a monthly basis.

15. The at least one non-transitory computer-readable medium of claim 9, having additional computer-executable instructions stored thereon that, when executed, further cause the at least one processor to:
in response to replacing the first set of one or more coefficients with the second set of one or more coefficients to recalibrate the modeling function, generate a report indicating that the first set of one or more coefficients has been replaced by the second set of one or more coefficients; and
transmit the report to one or more users.

16. An apparatus, comprising:
at least one processor; and
memory storing computer-readable instructions that, when executed by the at least one processor, cause the apparatus to:
receive a first identifier identifying a modeling function that models performance data, the modeling function having at least one input variable and a first set of one or more coefficients;
receive updated performance data from a data source, the updated performance data including at least one input value corresponding to the at least one input variable;
calculate a second set of one or more coefficients for the modeling function based on the updated performance data;
determine whether the modeling function more accurately models the updated performance data when the second set of one or more coefficients is used in computing at least one result of the modeling function instead of the first set of one or more coefficients; and
in response to determining that the modeling function more accurately models the updated performance data when the second set of one or more coefficients is used in computing the at least one result, replace the first set of one or more coefficients with the second set of one or more coefficients to recalibrate the modeling function.

17. The apparatus of claim 16, wherein determining whether the modeling function more accurately models the updated performance data includes:
computing a first population stability index value for the modeling function using the first set of one or more coefficients;
computing a second population stability index value for the modeling function using the second set of one or more coefficients; and
in response to determining that the second population stability index value is less than the first population stability index value, determining that the modeling function more accurately models the updated performance data when the second set of one or more coefficients is used in computing the at least one result.

18. The apparatus of claim 16, wherein determining whether the modeling function more accurately models the updated performance data includes:
computing a first Kolmogorov-Smirnov (K-S) metric value for the modeling function using the first set of one or more coefficients;
computing a second K-S metric value for the modeling function using the second set of one or more coefficients; and
in response to determining that the second K-S metric value is greater than the first K-S metric value, determining that the modeling function more accurately models the updated performance data when the second set of one or more coefficients is used in computing the at least one result.

19. The apparatus of claim 16, wherein determining whether the modeling function more accurately models the updated performance data includes determining that the modeling function captures a higher percentage of bad accounts when the second set of one or more coefficients is used in computing the at least one result.

20. The apparatus of claim 16, wherein the modeling function is a risk model that quantifies risk associated with one or more credit accounts of a financial institution.

21. The apparatus of claim 16, wherein the modeling function is recalibrated on a monthly basis.

22. The apparatus of claim 16, wherein the memory stores additional computer-readable instructions that, when executed by the at least one processor, cause the apparatus to:
in response to replacing the first set of one or more coefficients with the second set of one or more coefficients to recalibrate the modeling function, generate a report indicating that the first set of one or more coefficients has been replaced by the second set of one or more coefficients; and
transmit the report to one or more users.
